(19) United States
(12) Patent Application Publication
(10) Pub. No.: US 2026/0024126 A1
(43) Pub. Date: Jan. 22, 2026

(54) DEVICE FOR PROVIDING PERSONALIZED BEAUTY PROFILING AND GUIDANCE TO A USER AND A METHOD THEREOF

(71) Applicant: Anand Bidarkar, Thane (IN)

(72) Inventor: Anand Bidarkar, Thane (IN)

(73) Assignee: SkinMinds Derma Private Limited, Mumbai (IN)

(21) Appl. No.: 19/270,474

(22) Filed: Jul. 16, 2025

(30) Foreign Application Priority Data
Jul. 16, 2024 (IN) 202421054384

(51) Int. Cl. G06Q 30/0601

(52) U.S. Cl. CPC G06Q 30/0631

(57) ABSTRACT

A system, device (100) and a method (50) for providing personalized beauty profiling and guidance to a user is disclosed. The device (100) includes a data acquisition subsystem (11) comprising one or more multimodal modules (11A) configured for acquiring data associated with the user; and a processing subsystem (12A). The processing subsystem (12A) is configured for processing the acquired data for generating a personalized module (16) for providing personalized beauty profiling and guidance to the user, wherein the personalized module (16) comprises a device generated data file (16A) encapsulating the user's personalized beauty condition, and facilitating active beauty care through the personalized module (16) by interfacing the personalized module (16) with one or more of dedicated devices for providing differential information to different stakeholders.

### FIELD OF THE DISCLOSURE

The present disclosure generally relates to Artificial intelligence (AI) and healthcare, and more particularly relates to a system, a device, and a method for providing personalized beauty profiling and guidance to a user.

### BACKGROUND

In recent years, the beauty industry has seen a shift towards personalization in beauty care and cosmetic services. This shift has been driven by industry leaders and has significantly impacted smaller entities, especially beauty salons. Salons primarily generate revenue through cosmetic procedures and product sales, and the advent of personalization technologies poses a significant threat to this business model. Personalized facial aesthetic and skincare solutions are fast becoming essential in a global market inundated with numerous products and treatments. Unsuitable selection delivers subpar results and may even lead to undesirable effects, and hence consumers strive to identify the most appropriate solutions for their unique requirements.

Current personalization solutions can be broadly classified into regular photography based and specialized facial imaging. Regular photography-based devices, like cell phones, often suffer from inaccuracies stemming from variable lighting conditions and client's photography skills, which substantially affect the subsequent analysis of the client's skin condition. Specialized facial imaging devices, while providing more precise imaging, are often expensive, restricting their widespread adoption. A significant shortcoming common to both categories of imaging-based devices is their excessive reliance on a singular data modality, while neglecting crucial information related to actual skin surface properties and the individual's goals, health and lifestyle. Moreover, these devices are configured to process static photos and are unable to map dynamic changes on the face during movement. The absence of this data diminishes the credibility and effectiveness of the output generated by these devices.

Consumer awareness of different aspects of facial aesthetic and skincare solutions is on the rise. They have started to expect and appreciate being involved in their diagnosis and treatment decisions. The currently available devices are not geared for real time engagement for educational purposes and confidence-building in recommended treatments.

Clients are no longer passive recipients of beauty procedures and product recommendations. They expect salon staff to engage in scientific discussions about their beauty needs, answer their queries about procedures, and convince them of their expertise. However, clients too face several challenges in their beauty care journey. Selecting beauty products and procedures suitable for their unique needs can be overwhelming due to the vast array of options and guides. Furthermore, they often encounter inconsistencies in service personnel and recommendations when they are attended to by a different employee in the same salon or when visiting a different salon. This disjointed beauty care may lead to suboptimal results and a lower client satisfaction.

To address this changing environment, beauty salons need to equip their professionals with tools that enhance the overall client experience. This can be achieved by providing further education on personalization trends in the market, and by equipping salons with devices that offer an objective basis for recommending cosmetic procedures. Additionally, real-time client engagement in the personalization process can help clients understand their specific beauty needs and increase the uptake of beauty procedures. While these steps can enable salon professionals to convincingly propose specific procedures and products to clients, salons need to do more to compete with new-age players like value-added e-commerce sites and client aggregators that use mobile and store-based imaging technology to recommend beauty care routines and products. To counter this, salons need equipment that boasts superior components and methodology, overcoming the limitations of current personalization solutions that often rely solely on image-based data. They need to demonstrate a more comprehensive and accurate approach, thereby convincing the clients of the superior quality and reliability of their personalized beauty recommendations. To counter the IT capabilities of online players and ensure client loyalty, salons need a device-linked mechanism to support longitudinal care of clients. This includes maintaining a record of previous beauty procedures and client aspirations, which can be referred to when recommending the next course of action.

Accordingly, there is a need for a device, system, and a method that overcomes at least some of the above-mentioned limitations.

### SUMMARY

This summary is provided to introduce a selection of concepts, in a simplified format, that are further described in the detailed description of the disclosure. This summary is neither intended to identify key or essential inventive concepts of the disclosure nor is it intended for determining the scope of the disclosure.

To overcome at least one of the problems in the state of the art, there is a need for a more personalized, data-driven, a multimodal, interactive facial diagnostic system.

According to one embodiment of the present disclosure, a device for providing personalized beauty profiling and guidance to a user. The device includes a data acquisition subsystem comprising one or more multimodal modules configured for acquiring data associated with the user. The device includes a processing subsystem configured for processing the acquired data for generating a personalized module for providing personalized beauty profiling and guidance to the user. The personalized module may comprise a device generated data file loaded on to a physical carrier encapsulating the user's personalized beauty condition and facilitating active beauty care through the personalized module by interfacing the personalized module with one or more of compatible devices for providing differential information to different stakeholders.

According to another embodiment of the present disclosure, a method for providing personalized beauty profiling and guidance to a user. The method includes acquiring data associated with the user. The method includes processing the acquired data for generating a personalized module for providing personalized beauty profiling and guidance to the user, wherein the personalized module comprises a device generated data file encapsulating the user's personalized beauty condition. The method includes facilitating active beauty care through the personalized module by interfacing the personalized module with one or more of dedicated devices for providing differential information to different stakeholders.

According to yet another embodiment of the present disclosure, a system for enabling a Personal Beauty Key in an Internet of Things environment is disclosed. The system includes an integrated device equipped with a Personal Beauty Key generator configured for creating an IoT compliant Personal Beauty Key in both physical and digital formats. The system includes a Personal Beauty Key reader, comprising one or more modules configured for scanning the Personal Beauty Key, retrieving and transmit the scanned data to an associated remote server and displaying data received from the remote server to a user. The system includes an IoT interface, specifically configured for Personal Beauty Key-linked aspects, configured to enable bi-directional information transfer from the Personal Beauty Key to compatible IoT beauty care devices.

To further clarify the advantages and features of the present disclosure, a more particular description of the disclosure will be rendered by reference to specific embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates a device for providing personalized beauty profiling and guidance to a user, according to an embodiment of the present disclosure;

FIG. 1A is a block diagram that illustrates components of a system for multimodal beauty profiling with real-time client interaction, according to an embodiment of the present disclosure;

FIG. 1B is a block diagram that illustrates the functional classification of components of a system for multimodal beauty profiling with real-time client interaction, according to an embodiment of the present disclosure;

FIG. 1C illustrates the components that may be physically located in the Central Housing Unit of the device of FIG. 1, according to an embodiment of the present disclosure;

FIG. 2 is a block diagram that illustrates one or more components of the lighting control subsystem and components of the client engagement subsystem of device of FIG. 1, according to an embodiment of the present disclosure;

FIG. 2A depicts a cross section of an exemplary set up of one or more components of the dynamic lighting mechanism, and lighting output adjusters (LOAs) of the lighting control subsystem, and one or more components of the client engagement subsystem, according to an embodiment of the present disclosure;

FIG. 3 is a block diagram that illustrates the components of an imaging module of the data acquisition subsystem, according to an embodiment of the present disclosure;

FIG. 4 is a block diagram that illustrates the components of a non-imaging module of the data acquisition subsystem, according to an embodiment of the present disclosure;

FIG. 5 is a block diagram that illustrates the components of the retractable cover module of the lighting control subsystem, according to an embodiment of the present disclosure;

FIG. 5A depicts an exemplary retractable cover module of the lighting control subsystem, that is portable and only covers the head and neck of the client, according to an embodiment of the present disclosure;

FIG. 5B depicts yet another exemplary retractable cover module of the lighting control subsystem, that is usually fixed on one side and covers the client fully, according to an embodiment of the present disclosure;

FIG. 5C depicts yet another exemplary retractable cover module of the lighting control subsystem, that is either portable or fixed on one side and covers the client fully, according to an embodiment of the present disclosure;

FIG. 6 is a block diagram that illustrates the components of the Client Input Unit, according to an embodiment of the present disclosure;

FIG. 7 illustrates a method for the profiling the facial aesthetics and beauty of a subject using multimodal data acquisition and delivering recommendations across a spectrum of cosmetic care options, according to some embodiments;

FIG. 8 is a block diagram that illustrates the components of the Personal Beauty Key subsystem and the flow of data through the subsystem, according to an embodiment of the present disclosure;

FIG. 9 is an illustration of the varied possible manifestations of the Personal Beauty Key and the Display screen of the Personal Beauty Key Card Reader, showing differential information display between a beauty salon and a beauty product seller, according to an embodiment of the present disclosure; and

FIG. 10 illustrates a method for providing personalized beauty profiling and guidance to a user, according to an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

For the purpose of promoting an understanding of the principles of the disclosure, reference will now be made to the various embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

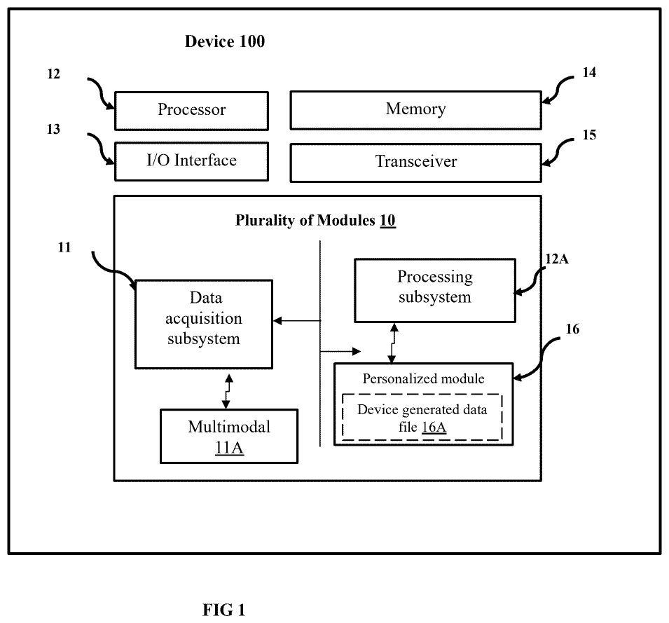

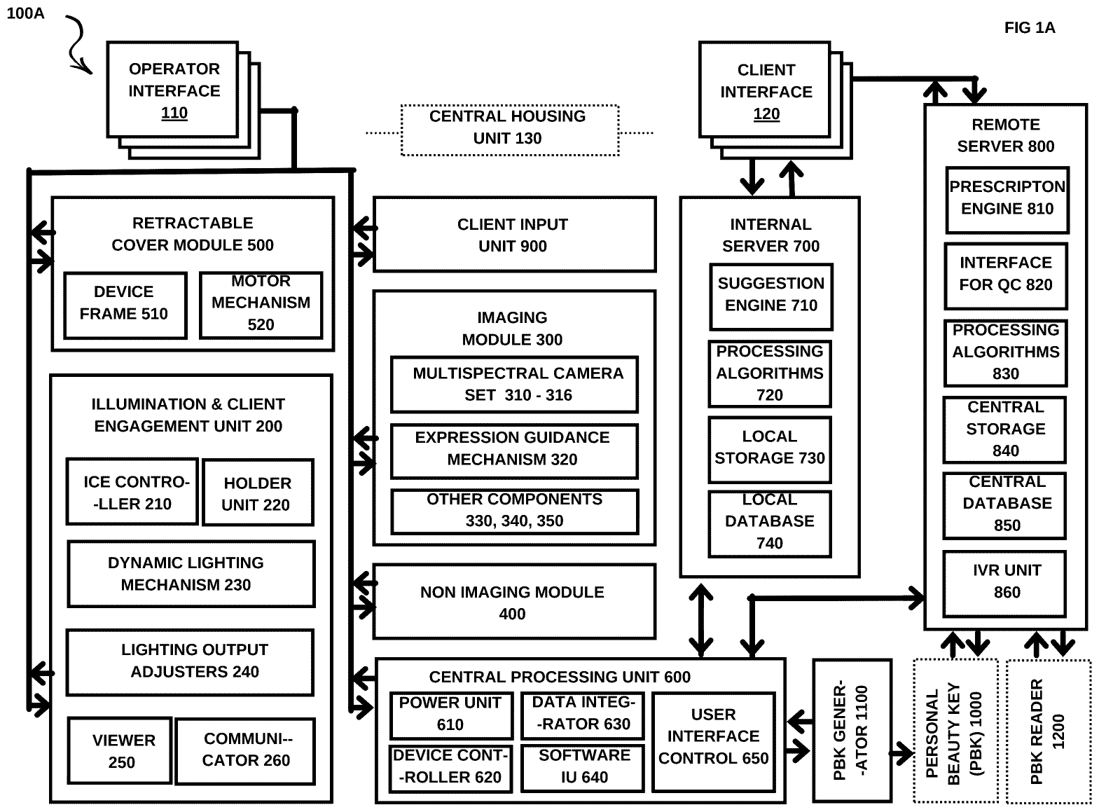

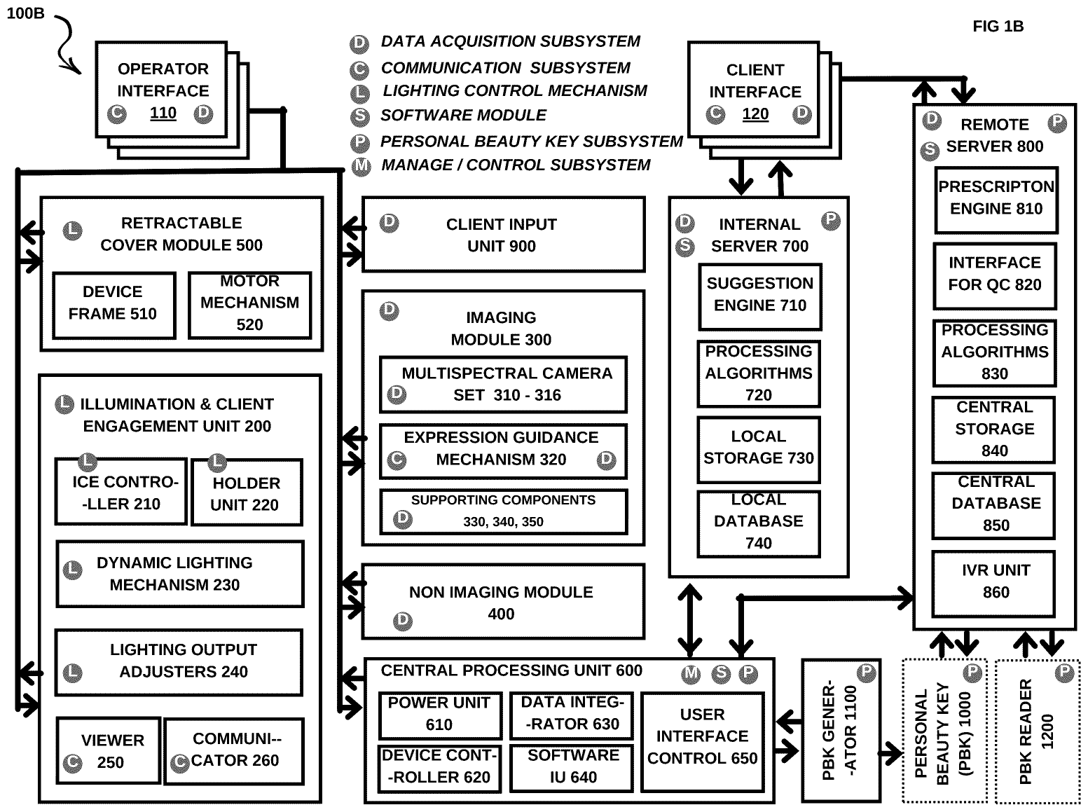

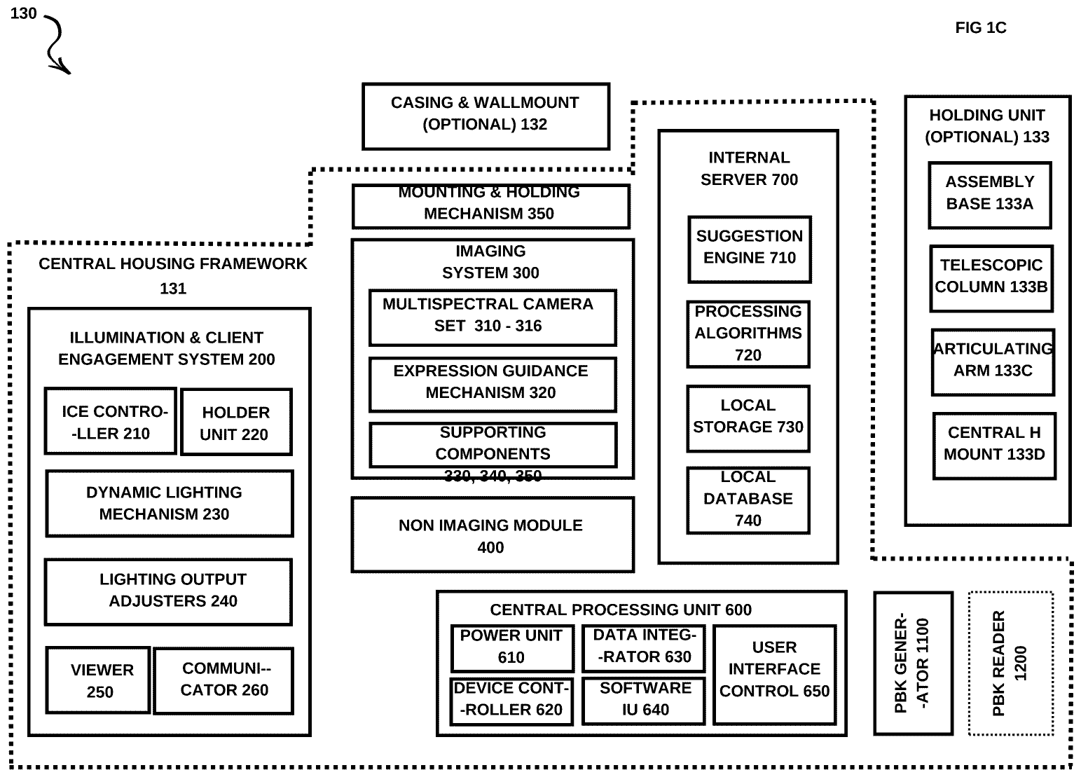

Reference is made to FIG. 1 which illustrates a block diagram of a device 100, according to an embodiment of the present disclosure. The device 100 may include a plurality of modules 10, a processor 12, an Input/Output (I/O) interface 13, a memory 14, a transceiver 15. The plurality of modules 10 may include a data acquisition subsystem 11 coupled to one or more multimodal 11A, a processing subsystem 12A and a personalized module 16.

In an exemplary embodiment, the processor 12 may be operatively coupled to each of the I/O interface 13, the plurality of modules 10, the transceiver 15, and the memory 14. In one embodiment, the processor 12 may include a graphical processing unit (GPU) and/or an Artificial Intelligence Engine (AIE). In one embodiment, the processor 12 may include at least one data processor for executing processes in virtual storage area network. The processor 12 may include specialized processing units such as integrated system (bus) controllers, memory management control units, floating point units, graphics processing units, digital signal processing units, etc. In one embodiment, the processor 12 may include a central processing unit (CPU), a graphics processing unit (GPU), or both. The processor 12 may be one or more general processors, digital signal processors, application-specific integrated circuits, field-programmable gate arrays, servers, networks, digital circuits, analog circuits and combinations thereof, or other now known or later developed devices for analyzing and processing data. The processor 12 may execute a software program, such as code generated manually (i.e., programmed) to perform the desired operation.

The processor 12 may be disposed in communication with one or more input/output (I/O) devices via the I/O interface 13. In some embodiments, the processor 12 may communicate with the one or more electronic devices 210 using the I/O interface 13. The I/O interface 13 may employ near field Communication (NFC), Bluetooth, communication code-division multiple access (CDMA), high-speed packet access (HSPA+), global system for mobile communications (GSM), long-term evolution (LTE), WiMax, or the like, etc.

Using the I/O interface 13, the device 100 may communicate with one or more I/O devices. For example, the input device may be an antenna, microphone, touch screen, touchpad, storage device, transceiver, video device/source, etc. The output devices may be a video display (e.g., cathode ray tube (CRT), liquid crystal display (LCD), light-emitting diode (LED), plasma, Plasma Display Panel (PDP), Organic light-emitting diode display (OLED) or the like), audio speaker, etc.

The processor 12 may be disposed in communication with a communication network via a network interface. In an embodiment, the network interface may be the I/O interface 13. The network interface may connect to the communication network to enable connection of the device 100 with the electronic devices comprising an personalized module 16 and/or outside environment. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, etc. Using the network interface and the communication network, the device 100 may communicate with other devices.

In some embodiments, the memory 14 may be communicatively coupled to the processor 12. The memory 14 may be configured to store data and instructions executable by the processor 12. In another embodiment, the memory 14 may be provided via a cloud-based unit. In yet another embodiment, the memory 14 may communicate with the processor 12 via a bus within the device 100. In yet another embodiment, the memory 14 may be located remote from the processor 12 and may be in communication with the processor 12 via a network. The memory 14 may include, but not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 14 may include a cache or random-access memory for the processor 12. In alternative examples, the memory 14 is separate from the processor 12, such as a cache memory of a processor, the system memory, or other memory. The memory 14 may be an external storage device or database for storing data. The memory 14 may be operable to store instructions executable by the processor 12. The functions, acts or tasks illustrated in the figures or described may be performed by the programmed processor 12 for executing the instructions stored in the memory 14. The functions, acts, or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing, and the like.

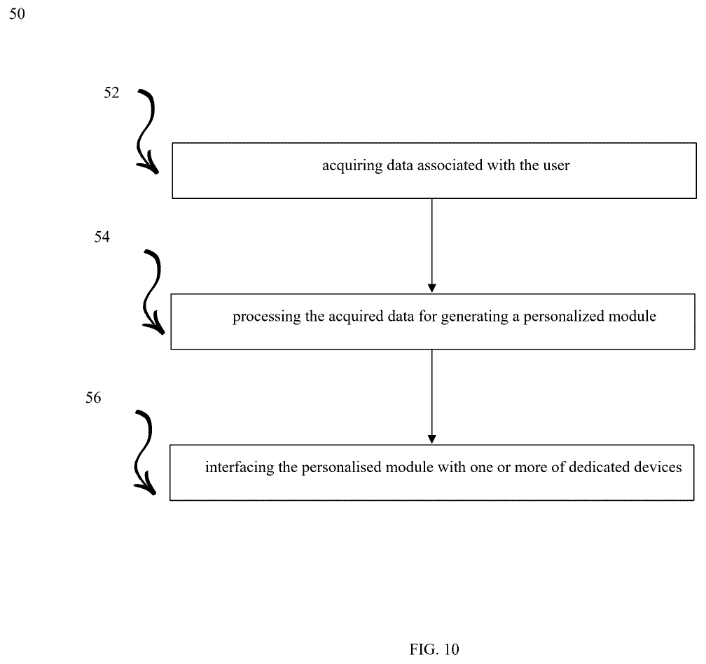

In some embodiments, the plurality of modules 10 may be included within the memory 14. The memory 14 may further include a database to store data. The plurality of modules 10 may include a set of instructions that may be executed to cause the device 100, in particular, the processor 12 of the device 100, to perform any one or more of the methods/processes disclosed herein. The plurality of modules 10 may be configured to perform the steps of the present disclosure using the data stored in the database. For instance, the plurality of modules 10 may be configured to perform the steps disclosed in FIG. 10. In an embodiment, each of the plurality of modules 10 may be a hardware unit which may be outside the memory 14. Further, the memory 14 may include an operating system for performing one or more tasks of the device 100, as performed by a generic operating system.

The transceiver 15 may be configured to receive and/or transmit signals to and from the one or more electronic devices (user devices associated with the users, or compatible devices or dedicated devices associated with the stake holders). In one embodiment, the database may be configured to store the information as required by the plurality of modules 10 and the processor 12 to perform one or more functions as disclosed in FIG. 10.

The plurality of modules 10 may be implemented by way of suitable hardware and/or software applications. In some embodiments, at least one of the plurality of modules 10 may use an AI model. A function associated with AI may be performed through the non-volatile memory, the volatile memory, and the processor 12.

The processor 12 may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a predefined operating rule stored in the non-volatile memory or may employ a suitable artificial intelligence (AI) model executed from a server or a local memory module.

Further, the present disclosure contemplates a computer-readable medium that includes instructions or receives and executes instructions responsive to a propagated signal. Further, the instructions may be transmitted or received over the network via a communication port or interface or using a bus (not shown). The communication port or interface may be a part of the processor 12 or may be a separate component. The communication port may be created in software or may be a physical connection in hardware. The communication port may be configured to connect with a network, external media, the display, or any other components in system, or combinations thereof. The connection with the network may be a physical connection, such as a wired Ethernet connection or may be established wirelessly. Likewise, the additional connections with other components of the device 100 may be physical or may be established wirelessly. The network may alternatively be directly connected to a bus. For the sake of brevity, the architecture and standard operations of the memory 14, the processor 12, the transceiver 15, and the I/O interface 13 are not discussed in detail.

In some embodiments, the words ‘client’, ‘user’, and ‘individual’ used in the description may refer to the person and are synonyms, in this context and may be used interchangeably. The Personal Beauty Key (PBK) is referred to as device generated data file 16A and is used interchangeably in the description. In some embodiments, the words ‘PBK’, ‘Personal Beauty Key’ 16A, and ‘device generated data file 16A’ used in the description may refer to same and may be used interchangeably.

Embodiments of the present disclosure falls broadly within the realm of beauty and aesthetics, and more specifically, it pertains to a device and system configured for generating and facilitating the function of a Personal Beauty Key (PBK), a personal beauty enhancement guide tool, intended for use in beauty salons and similar settings. The disclosure also pertains to the integration of physical components with custom-developed artificial intelligence (AI), machine learning (ML), sensor technology, IoT and computer vision. These digital technologies are not standalone but are intricately tied to the device's specific hardware configuration, thereby limiting their use independently of the device. A key aspect of this disclosure is the real-time engagement and education of clients, enhancing their involvement in beauty decision-making and potentially increasing the acceptance of recommended procedures. Another field that this disclosure addresses is the growing trend of personalization in the beauty industry. This disclosure provides tailored beauty recommendations all based on the unique needs and preferences of each client. The disclosure also addresses the field of integrated beauty care as the PBK can be used to communicate with multiple beauty stake holders, facilitate longitudinal beauty evaluation and tailored beauty care.

The present disclosure is a non-medical, personal beauty guide generating device, configured for use in beauty salons and similar settings. The device employs a high-resolution camera, multispectral lighting system, user interfaces and tactile sensors to capture precise measurements of beauty parameters. It also collects data on environmental factors, client concerns, and lifestyle habits, all of which can influence beauty.

The collected data is processed by a custom-built multimodal data processing module 11A, specifically configured and optimized for the functioning of this device. This module uses advanced algorithms and leverages artificial intelligence and machine learning technologies, which are implemented through the device's specific hardware configuration, to interpret the data accurately.

The important embodiment of this disclosure is the creation of a Personal Beauty Key (PBK), a device system linked, unique physical and virtual identifier generated for each client that encapsulates their personalized beauty condition. The PBK is the gateway to access personalized beauty care suggestions, beauty product recommendations, and specify salon-based beauty procedures, tailored to the individual needs and preferences of each client. The PBK can be used to communicate with multiple beauty stakeholders, facilitate longitudinal beauty evaluation, and provide tailored beauty care.

Furthermore, the device supports real-time client education and engagement, helping clients understand their specific needs and the rationale behind the suggested beauty salon care. It also maintains a record of previous beauty routines and client aspirations, which can be referred to when recommending the next course of action. The device includes an objective scheduling and reminder system for the client's next visit, enhancing client engagement and retention. For the client, it is an easy-to-use tool that helps them receive personalized and continuing care for beauty maintenance and enhancement.

Referring again now to FIG. 1 to be read along with FIG. 1A, the device 100 is configured for providing personalized beauty profiling and guidance to a user.

The device 100 includes a data acquisition subsystem 11, comprising one or more multimodal modules 11A configured for acquiring data associated with the user. The one or more multimodal modules 11A configured for acquiring data associated with the user, in near real-time comprises: an imaging module 300, a non-imaging module 400 and a user input module (900).

The imaging module 300 is configured for guiding, detecting, capturing, and analysing beauty characteristics on the user's face and neck during dynamic facial movements, with the analysis focused on aesthetic aspects such as skin texture, colour uniformity, and visible signs of aging or environmental damage. The non-imaging module is one of non-invasive, tactile, and contact type is configured for obtaining skin measurements of the user. The user input module (900) is configured for allowing the user to indicate specific areas of concern on a facial image.

The device 100 includes a processing subsystem 12A configured for processing the acquired data for generating a personalized module 16. The personalized module 16 is configured for providing personalized beauty profiling and guidance to the user. The personalized module 16 comprises a device generated data file 16A encapsulating the user's personalized beauty condition. The personalized module 16 is configured for facilitating active beauty care through the personalized module 16 by interfacing the personalized module 16 with one or more of dedicated devices for providing differential information to different stakeholders. The active beauty care comprises one or more of providing personalized recommendations on skincare to the user comprising facial dimensions, dermatological treatments, cosmetic procedures, medical interventions, or any other relevant applications based on the generated results.

The steps for processing the acquired data for generating the personalized module 16 by the processing subsystem 12A comprises: integrating the acquired data received from the one or more multimodal modules 11A, applying machine learning techniques, or any other suitable methods to the integrated data for analysing and generating results of analysis, facilitating optional expert validation on the generated results, using the generated results for generating the device generated data file 16A, and presenting the device generated data file 16A to the user through a communication sub-system or other device interfaces.

In some embodiments, the personalized module 16 is one or more of an IoT based storage module and a virtual storage module and a remote based storage module and a set of devices embedded with readers devices and an on-demand Interactive Voice Response based beauty concierge service.

In one embodiment, the IoT based storage module is configured as a physical Personal Beauty Key, embedded with the device generated data file 16A encapsulating the user's personalized beauty condition. In one embodiment, the virtual storage module is configured as a virtual counterpart of the personal beauty key, stored as a secure, encrypted data file within the user's user device, the user device comprising the device generated data file 16A encapsulating the user's personalized beauty condition.

In one embodiment, the remote based storage module, accessible by the Personal Beauty Key through an application installed on the user device, configured to store, update, and process the device generated data file 16A encapsulating the user's personalized beauty condition. In one embodiment, a set of devices embedded with readers devices enabling personalized beauty related communication and the reading of user beauty information. In another embodiment, an on-demand Interactive Voice Response based beauty concierge service, linked to the Personal Beauty Key, configured to provide personalized beauty care guidance to the user.

The personalized module 16 comprises a physical or virtual Personal Beauty Key Reader 1200 for securely accessing the contents of the Personal Beauty Key and for displaying stakeholder specific beauty care recommendations related to the user.

The Personal Beauty Key Reader 1200 includes:
a. a scanning component capable of reading a user's Personal Beauty Key,
b. a display component for presenting the personal beauty needs of the user to the beauty stakeholders upon scanning the personal beauty key,
c. a wired or wireless transmitting module programmed to facilitate data exchange between the Beauty Key Reader and the remote server associated with the device 100,
d. a custom built stakeholder interface for allowing the beauty stakeholders to upload their products and services to the database of the device 100, and
e. a device specific, beauty stakeholder ID protocol that facilitates the differential output by the Beauty Key Reader of user specific instructions to the beauty stakeholders, such as one or more of a suitable product or a service to be provided along with the ingredients to be used.

The device comprises or is coupled to an upgrading module (not shown) and is configured for periodically integrating additional data inputs acquired by the data acquisition subsystem 11, processing the additional data for dynamically updating the personalized module 16.

The device 100 comprises the communication sub-system comprising one or more interaction components configured for human or machine-based interaction with the user during the data acquisition process, the interaction components comprise, but not limited to a viewer (250) or visual display component, a two-way audio component, one or more of a screen or a reciprocal concave mirror and an interaction component.

In one embodiment, the viewer (250) or visual display component is configured for viewing the face or other related information associated with the user. In another embodiment, a two-way audio component configured for allowing verbal communication between the user, the device or the device operator. In yet another embodiment, a one or more of a screen and a reciprocal concave mirror configured for allowing the user to view their face during the data acquisition process. In another embodiment, the interaction component selected from a group comprising a haptic feedback and text-based messaging.

The communication subsystem is configured for displaying a portion of the acquired data on the one or more display components, while communicating with the user in real-time, including about the data displayed on the screen, during the data acquisition process through live interaction or machine-driven commentary.

The device 100 comprises a lighting control subsystem configured for creating a dynamically controlled lighting environment around the user and is mounted on a telescopic light stands, each stand having a top and bottom component connected with a joint that allows for angular movement of the top component, wherein the telescopic stands of the dynamic lighting mechanism are set in a structure that allows for movement in a fixed path to achieve appropriate light focus on the user's face.

The lighting control subsystem is one or more of a retractable cover module 500, a dynamic lighting units, a lighting output adjusters 240, a plurality of lights arranged around the viewing area, wherein the retractable cover module 5000 is configured with a retractable framework 510, that is controlled with a movement mechanism, optionally guided by a remote control to create a transient, light-controlled, private space in various shared environments, such as public halls, salons, spas, dormitories, or hospital wards.

The device 100 comprises a plurality of contact probes integrated, charged, and stored in a slot in the device 100 for obtaining cosmetic skin measurements related to beauty aspects, wherein the plurality of contact probes may be held on flexible structures. These structures may be operated manually or may comprise of robotic arms which are externally guided to enable the probes to touch the appropriate areas on the user's face, with the understanding that these measurements are in the nature of beauty analysis.

The device comprises a control sub-system comprising one or more control computers, that are in electronic communication with the components, one or more component operators, or the user's smart phone. The control computers comprise one or more processor units, computer programs with computer-readable memory units for executing a software module or any other tasks related to the device operation.

In addition to above, the device comprises an additional data acquisition component comprising a data acquisition component for allowing the user to collect facial data in different locations or environments and sending the data to the facial diagnostic device for analysis. In addition to above, the device comprises a communication module for storing the details in the Personal Beauty Key associated with transactions done at the beauty stakeholder. The central processing unit, internal or external servers of the device 100 may be capable of communicating with the client's mobile device, associated with the Personal Beauty Key (PBK), for active, long-term engagement. In one example, the central control unit, may be an internal or external servers that may be capable of communicating with the client's device, which could be a cell phone, for long-term engagement through a connected app.

FIG. 1A is a block diagram 100A that illustrates components of a system for multimodal beauty profiling with real-time client interaction and FIG. 1B is a block diagram 100B that illustrates the functional classification of components of a system for multimodal beauty profiling with real-time client interaction, according to an embodiment of the present disclosure. FIG. 1C illustrates the components 130 that may be physically located in the Central Housing Unit of the Device 100, according to an embodiment of the present disclosure.

As depicted in FIGS. 1A, 1B and 1C, in preferred embodiments the device 100 comprises of the following key parts such as an operator interface 110, a client interface 120, a central housing unit 130, an illumination and client engagement unit 200, an imaging module 300, a non-imaging module 400, a retractable cover module 500, a central processing unit 600, an internal server 700, a remote server 800, a client input unit 900, a Personal Beauty Key 1000, a Personal Beauty Key Generator 1100, and a Personal Beauty Key Reader 1200. Each key part may have several components that are described in detail in the following texts at sections describing the key parts.

FIG. 1C illustrates the components that may be physically located in the Central Housing Unit 130 of the Device, according to an embodiment of the present disclosure. The key components include a base assembly 133A, a telescopic column 133B, an optional articulating arm 133C and a central housing unit mount 133D.

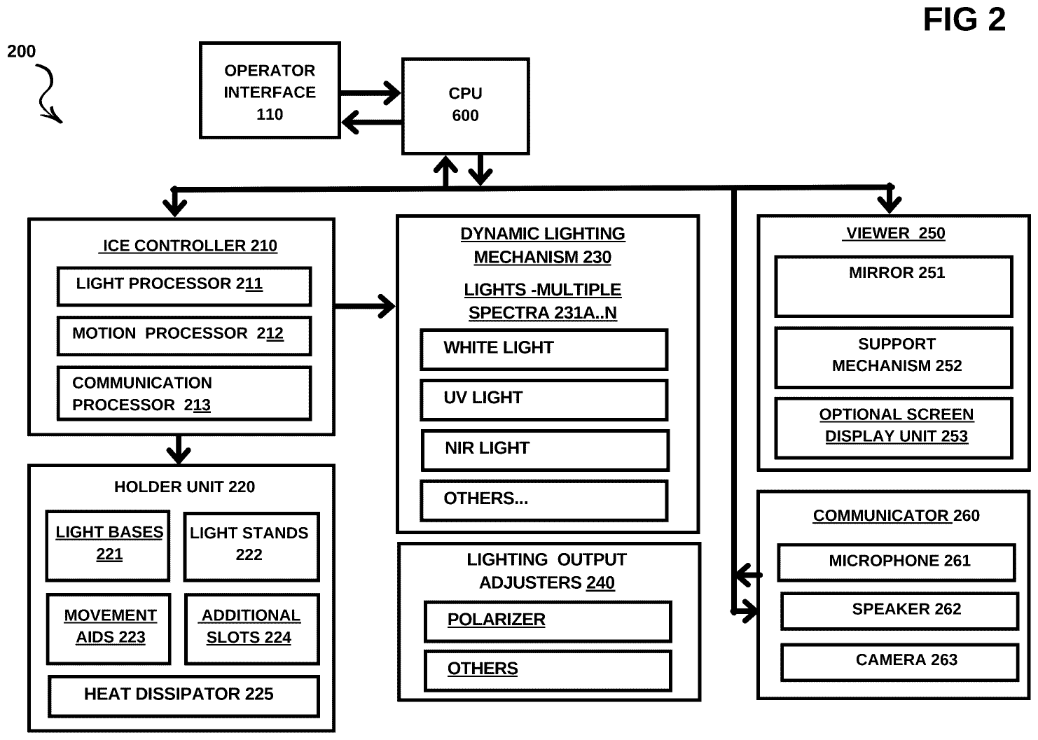

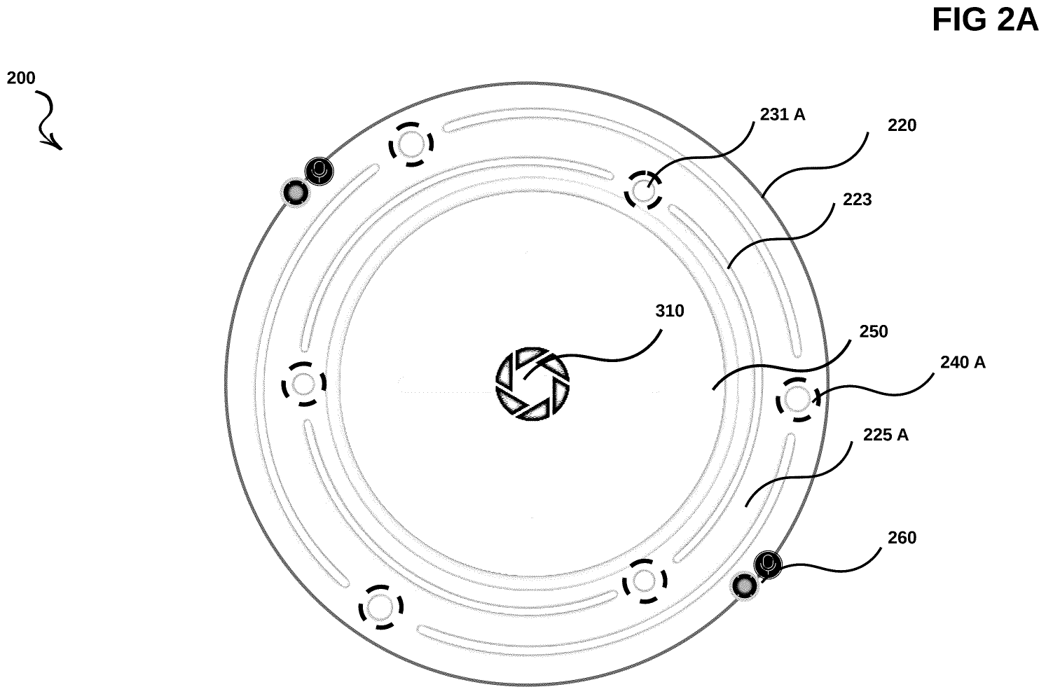

FIG. 2 is a block diagram 200 that illustrates one or more components of the lighting control subsystem and components of the client engagement subsystem. FIG. 2A depicts a cross section of an exemplary set up of one or more components of the dynamic lighting mechanism, and lighting output adjusters (LOAs) 240 of the lighting control subsystem, and one or more components of the client engagement subsystem.

As depicted in FIG. 1B, in preferred embodiments the components of the key parts may be classified as belonging to one or more functional subunits to depict the various aspects of the functioning of the device. The components are together named as the illumination and client engagement unit.

These comprises a data acquisition subsystem (D) with multiple modules for collecting facial data, a communication subsystem (C) for real-time interaction with the client, a lighting control mechanism (L) for a controlled lighting environment, a software module (S) for processing the collected data, a Personal Beauty Key subsystem (P) for managing all aspects of the Personal Beauty Key and a manage/control system (M) for managing the device components. The various components are synchronized through physical or digital connections. The following is a detailed description of the key parts of the of the device:

### The Operator Interface 110

As depicted in FIGS. 1A-B and FIG. 2, in preferred embodiments, the Operator Interface 110 is a crucial component of the device 100 that enables the operator to perform all necessary manual functions for the device's smooth operation. It can consist of single or multiple units and can be partially or fully digital. The Operator Interface 110 is connected to the Central Processing Unit (CPU) 600 through wired or wireless technology. In preferred embodiments, the Operator Interface 110 features a touch-sensitive display screen along with one or more physical buttons. Some embodiments feature a touchscreen display with a diagonal size of about 10 inches, providing a sufficiently large screen for clear visualization of beauty analysis results, Personal Beauty Key (PBK) 1000 information, and comfortable navigation. In other embodiments, a separate wirelessly connected tablet or smartphone may serve as the display touchscreen. Preferred embodiments also feature a PBK reader 1200 that is equipped to scan the PBK 1000 to access necessary information for the continuing beauty care of the client.

In some embodiments, the display is mounted on an adjustable arm for efficient operator management. Preferred embodiments also include a microphone and speaker to facilitate two-way interaction with the client during the imaging process. The Operator Interface 110 provides an operator-friendly platform to operate the device, interact with the client, interpret the beauty profile effectively, and manage the generation and use of the Personal Beauty Key (PBK) 1000.

### The Client Interface 120

In some embodiments, the Client Interface 120 is a key component that enhances the client's engagement and personalization experience. In preferred embodiments, the Client Interface 120 is a separate unit with touchscreen functionality. In some other embodiments the client's smartphone, equipped with a compatible app, can serve as the Client Interface. The Client Interface 120 may securely connect to the external server 800 or to the internal server 700 through the Central Processing Unit (CPU) 600 of the system, allowing for seamless data transmission. In some embodiments, the client can use the Client Interface 120 to answer relevant questions about environmental, medical, and lifestyle factors. A graphical or voice-enabled chatbot may interact with the client to obtain these answers in preferred embodiments.

In some embodiments, wherein the client interface is the mobile device of the client, the Client Interface 120 displays the virtual version of the PBK 1000. The PBK 1000 can be operated through unique credentials known to the client. The Client Interface 120 may also interact with the servers of the device, reading client specific data stored on it and updating it as necessary.

The Client Interface 120 provides a personalized and interactive platform for clients to actively participate in their beauty journey. This enhances client engagement and ensures that the beauty regimes recommended by the device align with the client's specific needs and expectations. The Personal Beauty Key (PBK) 1000, when embedded within the device, further enhances this personalization.

### The Central Housing Unit 130

As depicted in FIG. 1A, in some embodiments the central housing unit 130 is configured to securely house various components such as the illumination and client engagement unit 200, imaging module 300, non-imaging module 400, central processing unit 600, and internal server 700. It is constructed from high-quality, opaque materials, ensuring durability and aesthetic appeal suitable for a beauty salon environment.

In preferred embodiments, the unit 130 features a modular design, facilitating easy maintenance and upgrades, an essential feature for the dynamic and evolving beauty industry. It includes an organized wire management structure, ensuring a neat and professional appearance, and a separate compartment for the central processing unit 600, ensuring optimal performance.

In some embodiments, the imaging module 300 is housed in a specialized casing made from opaque, light-blocking materials. This casing includes vibration-dampening features and sealed connections, preventing light leakage and ensuring accurate beauty analysis.

In preferred embodiments, the central housing unit 130 also incorporates a ventilation mechanism. This mechanism dissipates heat generated by the device, ensuring longevity and safe operation. It also maintains a completely dark environment behind the viewer 250, which is crucial for accurate beauty analysis and optimal performance of the imaging module 300.

### The Illumination and Client Engagement (Ice) Unit 200

As depicted in FIG. 2, the Illumination and Client Engagement (ICE) unit 200 is a specialized component of the device 100, configured to facilitate comprehensive beauty analysis. In preferred embodiments, the ICE unit 200 comprises of an ICE Controller 210, a Holder 220, a Dynamic Lighting Mechanism 230, Lighting Output Adjusters (LOAs) 240, a Viewer 250 and a Communicator 260.

In preferred embodiments, the ICE unit 200 is connected to the central processing unit 600, ensuring seamless integration and communication within the device. It also interfaces with the operator interface 110, providing beauty salon professionals with real-time data and control over the beauty analysis process.

### The ICE (Illumination and Client Engagement) Controller 210

In some embodiments, the ICE (Illumination and Client Engagement) Controller 210 is an important component of the ICE unit 200. It manages the operation of the other components within the ICE unit 200. The ICE Controller 210 includes a Light Processor 211, a Motion Processor 212, and a Communication Processor 213.

In some embodiments, the Light Processor 211 may control the Dynamic Lighting Mechanism 230 and may also manage the operation of the Lighting Output Adjusters (LOAs) 240.

In some embodiments, the Motion Processor 212 may control the Dynamic Lighting Mechanism 240 to facilitate dynamic light positioning and adjustable illumination angles, offering adaptable illumination for various face surface structures of cosmetic nature. The Motion Processor 212 may also connect with the Holder 220 and control the operation of the Viewer 250.

In preferred embodiments the Communication Processor 213 manages the communication between the ICE unit 200 and the operator interface 110, ensuring seamless control over the beauty analysis process. The Communication Processor 213 is closely linked with the Communicator 260, which comprises of one or more Microphones 261, Speakers 262, and Cameras 263. The Communication Processor 213 also synchronizes with the Viewer 250.

### The Holder 220

As depicted in FIG. 2A, in preferred embodiments, the Holder 220 in the Illumination and Client Engagement (ICE) unit 200 is configured to hold the various components of the ICE unit in place. It incorporates dynamic light positioning and adjustable illumination angles offering adaptable illumination for various cosmetic face surface structures. This flexibility can result in more accurate beauty analysis by minimizing shadows and capturing features more effectively. The holder 220 may also incorporate additional slots 224 for the components of the light output adjusters 240, and components of the communicator 260 like the microphone 261 and speaker 262.

In some embodiments, the holder incorporates efficient heat dissipation mechanisms 225, such as aluminium heat sinks, to keep the light sources 231 at a safe operating temperature during extended use. In preferred embodiments, the holder 220 is configured to be aesthetically pleasing and match the decor of the salon. In some embodiments the holder is configured to be compact and portable, allowing it to be easily moved around the salon as needed. The holder may also be configured to be easy to clean and maintain.

### The Dynamic Lighting Mechanism 230

The Dynamic Lighting Mechanism 230 is a key component of the ICE unit 200. In some embodiments, it comprises one or more Light Sources 231 that generate light containing a spectrum of various component wavelengths, including but not limited to ultraviolet (UV), visible, infra-red, and near-infrared (NIR) bands. This facilitates comprehensive beauty analysis. Other embodiments may generate only one or more of these light wavelengths. In some other embodiments, the Light Source 231 may encompass a combination of broadband and narrowband light sources to ensure comprehensive illumination across various wavelengths.

In preferred embodiments, the Dynamic Lighting Mechanism 230 is configured to adapt to different analysis requirements by selectively activating the most suitable lighting design for each client and specific beauty condition. It incorporates several types of lighting mechanisms.

Direct Light: This is achieved by incorporating a direct light mechanism that emits parallel light beams. Pulsed Light: This is achieved by incorporating a pulsed light mechanism that emits light at specific intervals or synchronizes with the camera's 310 frame rate. This approach can minimize motion blur during imaging. Hybrid Direct and Diffused Lighting: This is achieved by combining direct and diffused lighting in the illumination unit to provide a balance between shadow reduction and face feature enhancement. The direct lighting can emphasize facial features, while the diffused lighting reduces shadows, creating an optimal environment for accurate beauty analysis. In some embodiments, the light may pass through a polarizer, removing any light that does not have a selected polarization. The polarization can be selected by rotating the polarizer accordingly.

### The Lighting Output Adjusters (LOAs) 240

As depicted in FIG. 2A, in some embodiments, the LOAs 240 are a critical part of the Dynamic Lighting Mechanism 230. They allow the system to adapt to different analysis requirements by selectively activating the most suitable lighting design for each client and specific beauty condition. In preferred embodiments the LOAs 240 work in conjunction with the Light Processor 211 of the ICE Controller 210 to fine-tune the lighting output, ensuring optimal illumination for beauty analysis. They play a crucial role in managing the different types of lighting mechanisms, such as Direct Light, Pulsed Light, Hybrid Direct and Diffused Lighting, and Polarized Light.

### The Viewer 250

In preferred embodiments the Viewer 250 in the Illumination and Client Engagement (ICE) unit 200 is configured to allow the client to witness their facial condition and features under different illumination conditions, when appropriate, during the data acquisition process. The viewer 250 could be a reflective surface like a mirror, or a smart display screen. In some embodiments the viewer 250 could be at a different position or absent.

In the context of a beauty salon, the viewer 250 serves as a real-time feedback mechanism for the client. It allows the client to see their face under different lighting conditions and magnification, where appropriate, which can help them understand the condition of their beauty better and appreciate the need for recommended beauty procedures or products.

In preferred embodiments, the viewer 250 is a reciprocal concave mirror 251 that allows a high-resolution camera to capture images through the mirror while still enabling the client to view their face. This design eliminates the need for a separate mirror and simplifies the overall device construction. In some embodiments, the mirror includes one or more uncoated slots or apertures for fixing of the high-resolution camera.

In some embodiments the reciprocal concave mirror is replaced by a smart mirror or a tablet computer screen 253 with fittings capable of playing video, audio and graphics. A few other embodiments have a face adjustment grid projected on the mirror or smart mirror screen to help the client rightly position their face during the image capture process. In some embodiments, a support mechanism 252 for the mirror which may be an adjustable mount or hinge allows clients or operators to change the mirror's angle for optimal viewing and lighting during the imaging process. The mount supports horizontal and vertical angle adjustments to accommodate different client heights and preferences.

### The Communicator 260

In preferred embodiments the Communicator 260 in the Illumination and Client Engagement (ICE) unit 200 is configured to provide a live or pre-recorded commentary matching the image on the viewer and/or the stage of illumination and what to expect. The communicator 260 components are controlled by the communication processor 213. In preferred embodiments, the communicator 260 comprises of one or more microphones 261, speaker/s 262, and camera/s 263. In some embodiments, the cameras 263 capture the client's image as seen in the mirror 251 under different lighting conditions. The communicator 260 serves as a tool for enhancing client engagement and providing real-time feedback. It may provide commentary on the client's beauty condition, explain the results of the beauty analysis, and provide recommendations for procedures or products. This can help the client understand their beauty better and make informed decisions about their beauty care regimen.

In some embodiments, the camera 263 can transmit the client's image displayed on the viewer 250 on to the operator interface 110 or any other compatible component. A remote or onsite Device operator can view the images via a connection with the CPU 600 and External Server 800 and provide an interactive, live commentary to the client. This feature can be particularly useful in a beauty salon setting, where it can facilitate real-time interaction between the client and the beauty professional, enhancing the overall client experience.

### The Imaging Module 300

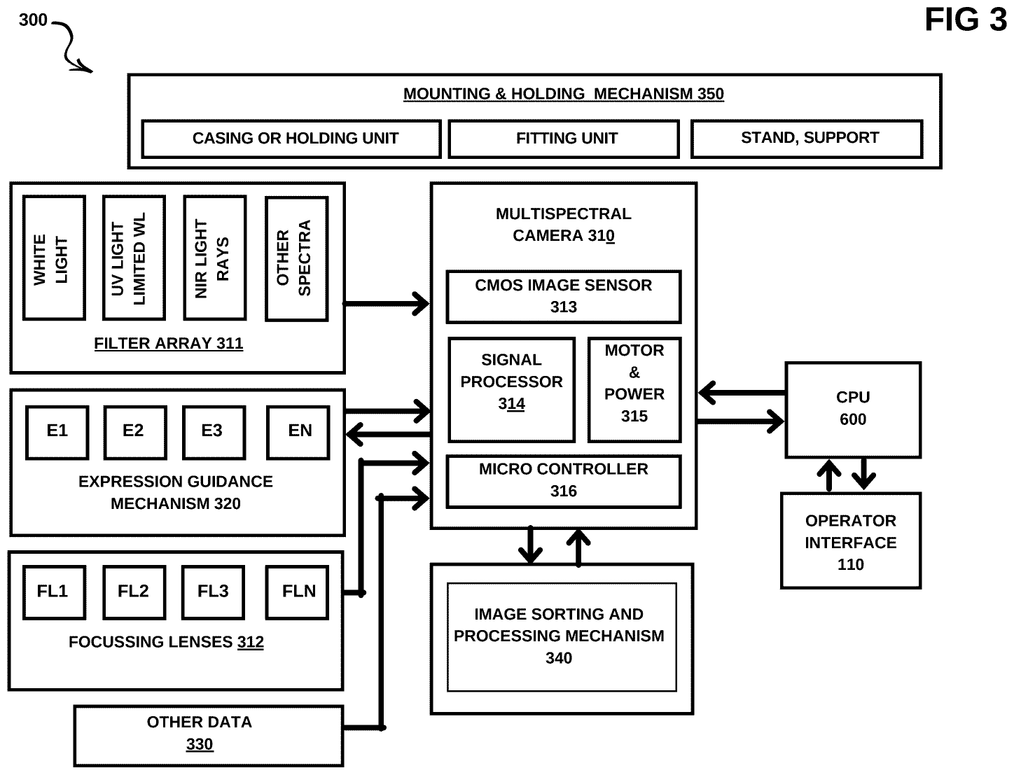

FIG. 2A and FIG. 3 is a block diagram that illustrates the components of an imaging module of the data acquisition subsystem 11 of FIG. 1, according to an embodiment of the present disclosure.

As depicted in FIG. 3, the Imaging Module 300, is a part of the data acquisition subsystem 11. In preferred embodiments, it features one or more high-resolution Multi spectral cameras 310 placed inside a mounting and holding mechanism 350 and mounted on a flexible, multi-axis joint. These cameras 310 are configured to capture detailed images of the client's face from various angles for comprehensive beauty analysis.

The camera 310 is equipped with a high-quality CMOS sensor 313, with a preferred resolution of 12 megapixels or more, which ensures the capture of detailed images of the client's face. It is built to offer excellent low-light performance and support standard image formats, such as JPEG and RAW, for easy integration with analysis software and flexibility in post-processing. It is supported by a signal processor 314, a motor and power component 315, and a microcontroller 316.

The camera 310 has an image sorting and processing mechanism 340 that incorporates efficient image compression algorithms to minimize file size without sacrificing image quality. Some embodiments of the imaging subsystem 300 may incorporate a filter wheel or filter array 311 that help selectively capture images under one or more spectra of lights emitted by the ICE unit 200.

In accordance with several alternative embodiments, the imaging module 300 and the ICE unit 200 are synchronized, employing one or more of the following imaging modalities to facilitate comprehensive face analysis: Thermal Imaging Capability, 3D Imaging Capability, Polarized Light Imaging Capability, High-speed Imaging Capability. In some embodiments, the camera features an autofocus mechanism that quickly and accurately focuses on the client's beauty aspects during image capture. In other embodiments, only manual focus capabilities, or a mix of both are provided, allowing the operators to fine-tune the focus if necessary.

The Imaging Module 300 can provide detailed images of the client's beauty aspects, which can be used to recommend personalized beauty regimes and products. The ability to capture images under various lighting conditions and angles can help beauty professionals better understand the client's beauty needs and provide more effective procedures. The camera 310 is also capable of capturing high-resolution video, which is particularly useful in a beauty salon context. This video capture functionality allows for continuous monitoring of dynamic facial expressions and movements, providing a wealth of data for comprehensive beauty analysis. The high frame rate and fast shutter speed of the camera ensure smooth and detailed footage, minimizing motion blur and maintaining image sharpness during rapid facial movements. This feature is especially beneficial for capturing the effects of various beauty procedures over time, allowing beauty professionals to track progress and adjust cosmetic recommendations as necessary. The video capture functionality also enhances client engagement, as clients can visually see the changes in their beauty over time, adding to their overall salon experience.

### The Non Imaging Module 400

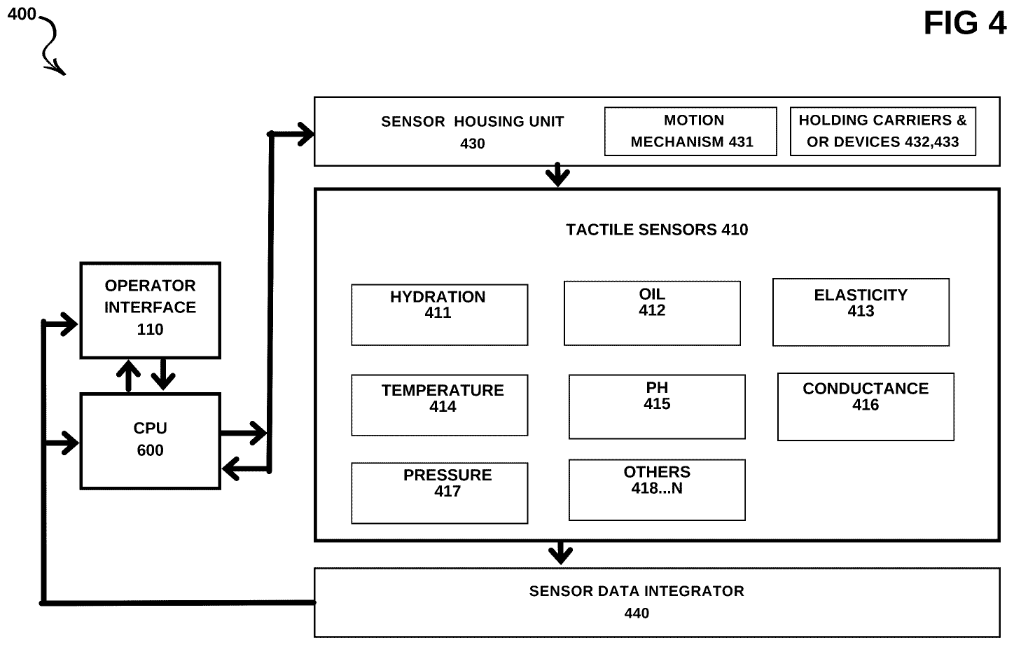

FIG. 4 is a block diagram that illustrates the components of a non-imaging module the data acquisition subsystem 11 of FIG. 1, according to an embodiment of the present disclosure.

As depicted in FIG. 4, In preferred embodiments, the Non-Imaging Module 400, as part of the data acquisition subsystem 11, comprises of a Tactile Sensor Unit 410, a Sensor Housing Unit 430, and a Sensor Data Integrator 440. These components are connected to each other and the Central Processing Unit (CPU) 600, either physically or through wireless mechanisms.

In some embodiments, the Tactile Sensor Unit 410 provides additional characterization of the beauty related aspects of the skin of a client. It includes sensors that measure inherent beauty related aspects of a subject's skin, and how it responds to external perturbations like pressure or optical signals.

The Tactile Sensor Unit 410 may include one or more of the following sensor types: a Hydration sensor 411, Oiliness (sebum) Sensor 412, a Elasticity Sensor 413, a Temperature Sensor 414, a pH Sensor 415, a Conductance Sensor 416, and a Pressure Sensor 417. Additional sensor types 418.N related to beauty may be present. The sensors are programmed to evaluate only beauty related aspects of the client's face.

In some embodiments, one or more sensors of the same type may be present. The sensors are mounted on one or more carriers 432 that are connected to the sensor housing unit 430. In other embodiments, one or more sensors could be a part of multiple independent units 433 connected to the sensor data integrator 440 through wired or wireless connections. It is also possible for the data to be manually entered into the sensor data integrator by the operator.

The sensor housing unit 430 holds the sensors directly through carriers or indirectly as a holder for independent sensor integrated carriers. It provides power supply for the independent sensor integrated carriers. In some embodiments the carriers are mounted onto a remote-controlled movement mechanism 431 that can be physically or remotely positioned to place the sensor on the appropriate anatomical location on the client.

### The Retractable Cover Module 500

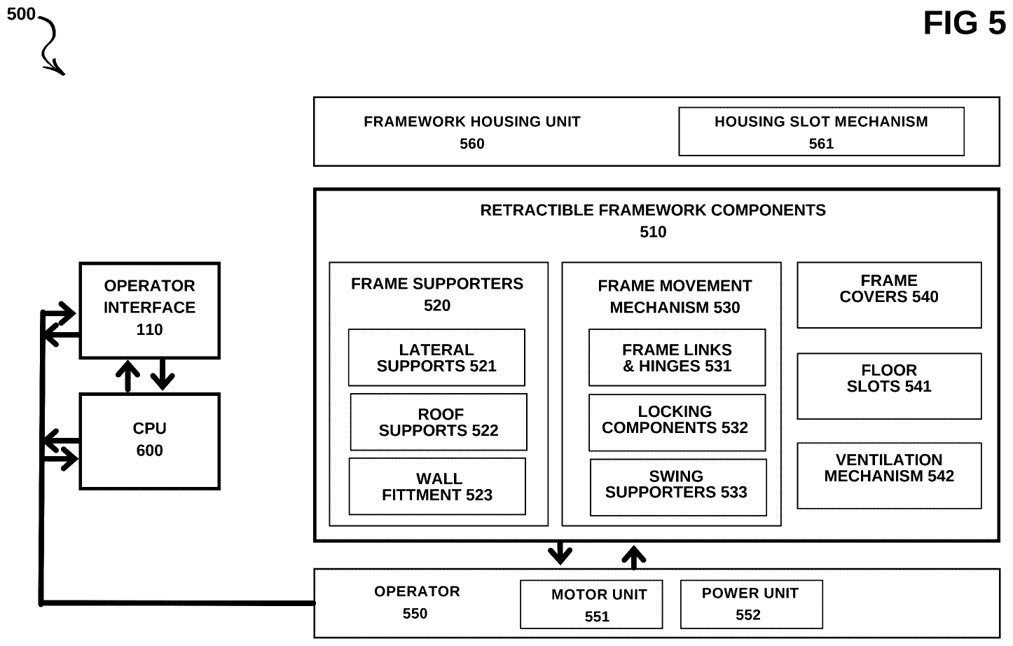

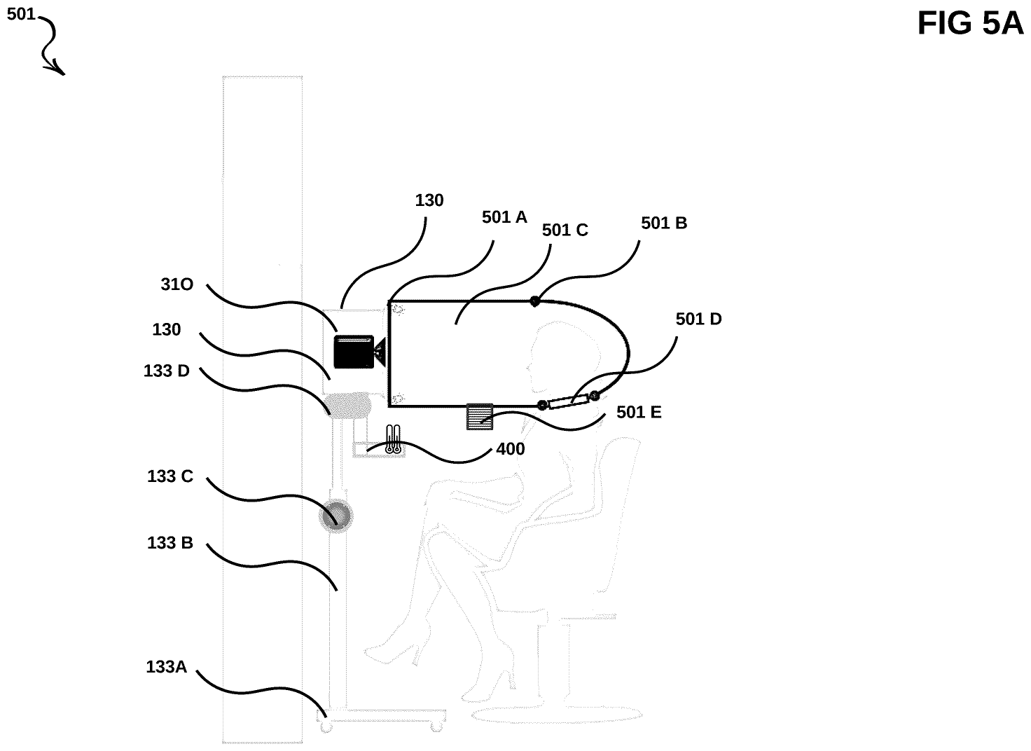

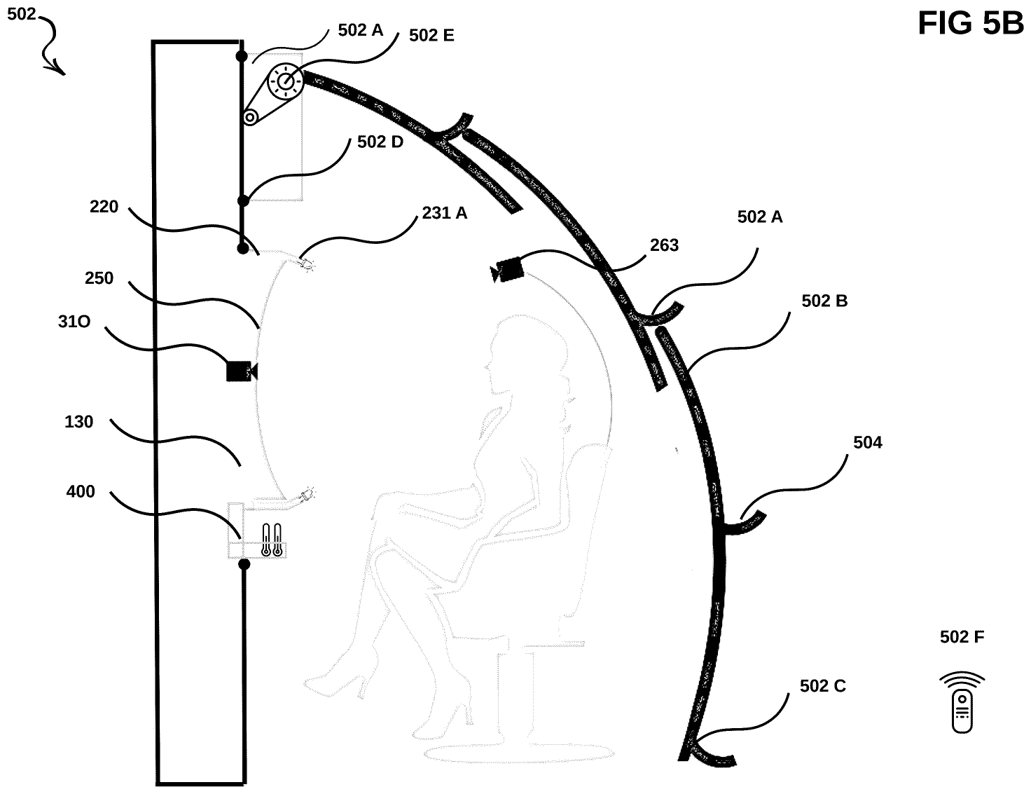

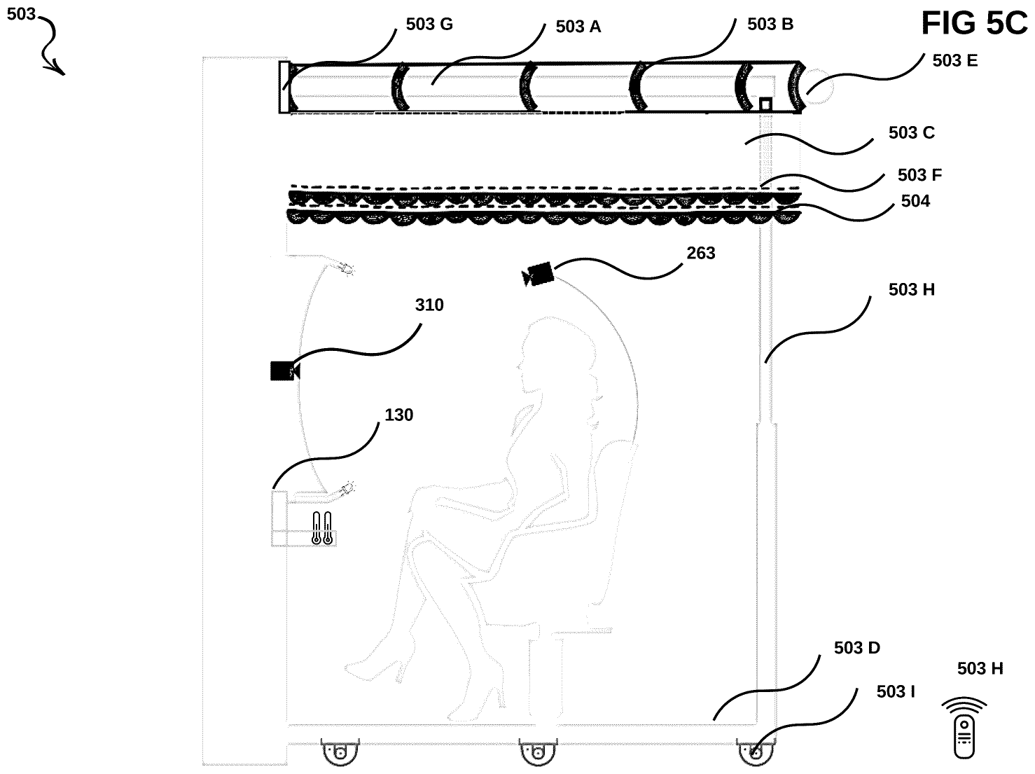

FIG. 5 is a block diagram that illustrates the components of the retractable cover module 500 of the lighting control subsystem, according to an embodiment of the present disclosure. As depicted in FIG. 5, In preferred embodiments, the Retractable Cover Module 500 is a key component of the device, configured to create a controlled lighting environment for accurate multispectral image capture of the client's face and neck.

Preferred embodiments of the retractable cover module 500 may comprise of a retractable framework 510, further comprising of frame supporters 520, frame movement mechanism 530, frame covers 540, floor slots 541, ventilation mechanism 542. The frame supporters 520 may comprise of lateral supports 521, roof supports 522, and a wall fitment 523. The frame movement mechanism 530 comprises of frame link and hinges 531, locking components 532, and swing supporters 533. An operator 550 comprising of a motor unit 551 and power unit 552 are used to deploy or retract the retractable framework 510. The components in a retracted state can be stored in a framework housing unit 560, by deploying the housing slot mechanism 561. The functioning of the retractable cover module 500 can be controlled by an operator through the operator interface 110 via the CPU 600.

The retractable cover module 500 may be created in distinct designs to cater to different salon environments, embodiments with three of the common designs are described herein:

FIG. 5A depicts an exemplary retractable cover module 500 of the lighting control subsystem, that is portable and only covers the head and neck of the client, according to an embodiment of the present disclosure. Such embodiments are highly portable and can be used in an on-field environment. The components of the holding component of the central housing unit are also depicted. FIG. 5B depicts yet another exemplary retractable cover module 500 of the lighting control subsystem, that is usually fixed on one side and covers the client fully. Such embodiments can quickly and transiently create a light controlled private space within a public hall and may be used in several such environments, for example in beauty salons and spas. FIG. 5C depicts yet another exemplary retractable cover module 500 of the lighting control subsystem, that is either portable or fixed on one side and covers the client fully. Such embodiments can quickly and transiently create a light controlled private space within a public hall and may be used in several such environments, for example in beauty salons and spas.

FIG. 5A depicts an exemplary retractable cover module 500 of the lighting control subsystem, that is portable and only covers the head and neck of the client, according to an embodiment of the present disclosure

Compact Cover 501: As depicted in FIG. 5A, this embodiment is configured to create a dark space just around the client's face and neck, offering a compact solution for blocking external light.

Convertible Wall Mounted Cover 502: As depicted in FIG. 5B, this embodiment is configured to create a larger dark space that can envelop the Central Housing Unit 130, the client, and potentially the seating equipment. It is wall-mounted and can be seamlessly integrated with the salon's decor.

Framework Mounted Cover 503: As depicted in FIG. 5C, this embodiment features a framework-mounted mechanism with a lightproof roof and retractable walls. It creates a spacious dark space around the Central Housing Unit 130 and the client, allowing for natural face dynamics.

Some embodiments of the Retractable Cover Module 500 include a cover can become see-through when external light is not a concern, and opaque when it needs to be blocked, offering flexibility in various lighting conditions.

The compact cover 501 embodiment can be used at the beauty salon as well as for client home visits by the staff at the beauty parlour. The compact cover 501 comprises of an Attachment Unit 501A, a Retractable Spherical Frame 501B, an Opaque Cover 501C, a Neck Slot 501D, Ventilation Openings 501E, and optional additional support props 501F.

The Attachment Unit 501A is equipped with a secure and adjustable strap or clamp mechanism that can be attached to the Central Housing Unit 130. The Retractable Spherical Frame 501B, made from lightweight yet sturdy materials such as aluminium or plastic, can be retracted when not in use and extended to envelop the client's face and neck during the analysis process. The Opaque Cover 501C prevents external light from interfering with the multispectral image capture.

Ventilation Openings 501E are integrated into the cover's design, allowing for airflow while maintaining the dark environment. These openings are equipped with adjustable covers or mesh screens to control the airflow and prevent light leakage.

### The Central Processing Unit (CPU) 600

In preferred embodiments, the Central Processing Unit (CPU) 600, as depicted in FIG. 1A and FIG. 1B, serves as the brain of the device, managing its various hardware and software components and processing client data to provide accurate beauty assessments and personalized recommendations.

The CPU 600 may manage and synchronize the operation of all components under 200, 300, 400, 500, 900 and may connect with internal 700 and external servers 800 as well as the operator 110 and client interface 120. This coordination ensures that the device operates smoothly and effectively during each beauty analysis session.

In preferred embodiments, the CPU 600 comprises of a Power Unit 610, Device Controller 620, Data Integrator 630, Software Implementation Unit 640, and the User Interface Management Unit 650.

The Power Unit 610 ensures consistent power supply for reliable operations. It may have either a rechargeable battery or an AC adapter or a combination of both. A charging port is incorporated into the device's design for convenient battery charging.

In some embodiments, the Device Controller 620 comprises of a processor and a connectivity module. The processor allows for seamless integration among all components of the device and controls their functioning based on instructions embedded in pre-installed software. The Device Controller 620 continuously monitors the performance and health of the device and its components, identifying any potential issues or malfunctions. In some embodiments, the Data Integrator 630, in synchronization with the internal 700 and an optional external 800 server, processes the data acquired from the components of the data acquisition subsystem 11 of FIG. 1 and shares the recommendations with the operator and client, as appropriate through the operator interface 110 and the client interface 120.

In some embodiments, the Software Implementation Unit 640 connects with an internal server 700 and an optional external server 800 to process the data received from the data integrator 630 to generate accurate beauty assessments and personalized beauty care recommendations. The CPU 600, in coordination with the Software Implementation Unit 640 and the User Interface Management Unit 650, plays a crucial role in the generation of a Personal Beauty Key (PBK) for each client.

The User Interface Management Unit 650 of the CPU 600 connects with multiple components in the CPU 620, 640, the Servers 700, 800 and device's user interfaces 110 and 120. It transmits the beauty analysis results, beauty care recommendations, and any relevant alerts or notifications.

The CPU 600 has the capability to connect with authorized external data sources. This allows the CPU to receive and transmit information related to the client, further enhancing the personalization and accuracy of the beauty care recommendations. The CPU 600 is configured to accommodate future enhancements and improvements.

### Internal Server 700

In preferred embodiments, the internal Server 700 is responsible for facilitating the processing and storage of data. It may comprise of several hardware and software components, including:

Suggestion Engine 710: This component is responsible for generating personalized beauty care and procedure recommendations based on the analyzed facial data. It also plays a key role in the creation and updating of the Personal Beauty Key (PBK), which encapsulates the client's personalized beauty data.

Processing Algorithms 720: These algorithms process the facial data, identifying patterns and correlations that can provide insights into various beauty issues and their potential care. They also interact with the PBK, updating it based on new data and ensuring that the recommendations provided are tailored to the client's unique needs.

Local Storage 730: This component provides local storage for the device's data.

Local Database 740: This database stores device-specific data, including availability of beauty care products, appliances and procedures.

### External Server 800

In preferred embodiments the External Server 800 is a remote server, that may be cloud based, that provides additional storage and processing capabilities. It has several hardware and software components, that may comprise of

Recommendation Engine 810: This engine generates detailed beauty care recommendations based on the client's beauty analysis results and personal beauty goals. It also interacts with the Personal Beauty Key (PBK) 1000, using the information stored in the PBK to tailor the recommendations to the client's unique needs and preferences.

Interface for QC 820: This interface allows for quality control, ensuring the accuracy and reliability of the beauty analysis results and recommendations. It also monitors the integrity of the PBK, ensuring that the data stored in the PBK is accurate and up-to-date.

Processing Algorithms 830: Similar to the internal server, these algorithms process the beauty data to generate insights and recommendations. They also interact with the PBK, using the data stored in the PBK to enhance the accuracy and personalization of the recommendations.

Central Storage 840: This component provides additional storage space for client data, ensuring that all information is securely stored and easily accessible. It also stores the PBKs of clients, providing a backup of the PBK data and ensuring that the PBK can be easily retrieved if needed.

Central Database 850: This database stores all client data, including beauty analysis results, beauty care recommendations, and personal beauty goals, allowing for a comprehensive and personalized approach to beauty care. It also stores information related to the PBK, such as updates and changes made based on new data or client feedback.

Interactive Voice Response (IVR) unit 860: providing a voice-based interface for clients to interact with the external server. In conjunction with the IVR system 860, the external server provides support in situations where a PBK reader 1200 at a partner location fails to read the PBK or the client is unable to access the contents of the PBK 1000. Additionally, the external server enables the IVR system 860 to assist clients in selecting beauty care options in locations where PBK readers are not available, or for online purchases ensuring continuity of personalized care across different environments.

The Internal Server 700 and External Server 800 work together to provide a personalized and data-driven approach to beauty care, enhancing the client's experience and improving the effectiveness of the recommended procedures. They also play a crucial role in the management and updating of the PBK 1000, ensuring a seamless and personalized beauty care experience for the client.

### Client Input Unit 900

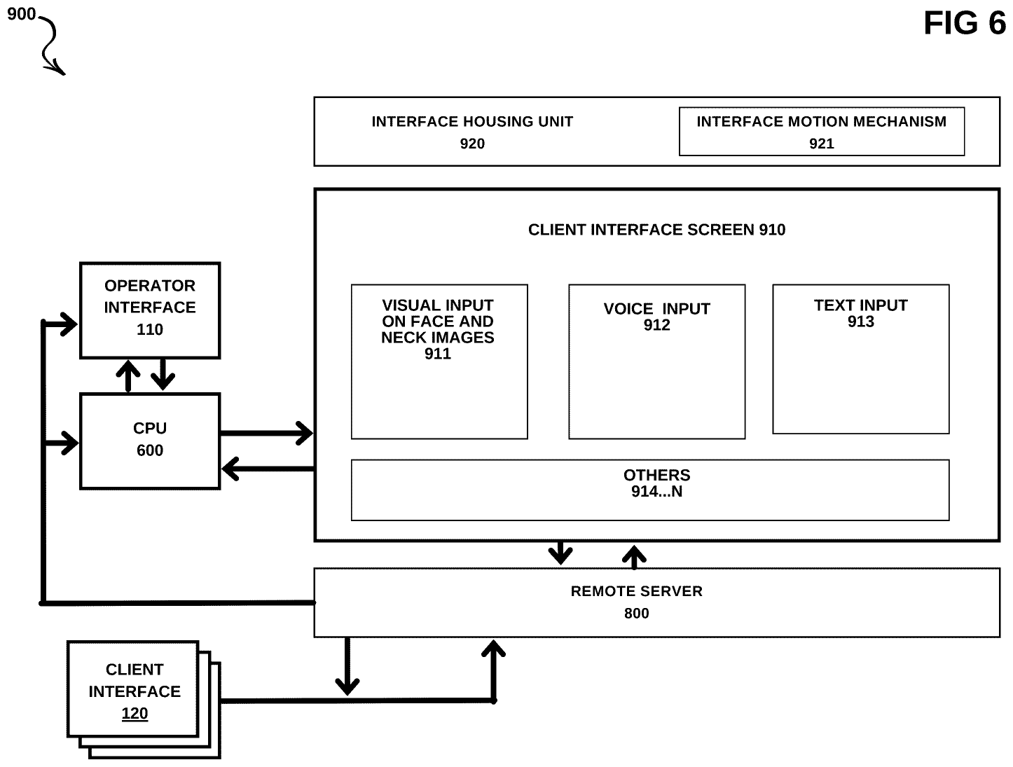

FIG. 6 is a block diagram that illustrates the components of the Client Input Unit, according to an embodiment of the present disclosure.

In some embodiments, the Client Input Unit 900, as depicted in FIG. 6, is configured to capture the client's beauty care goals graphically. It can be a separate handheld component or integrated into the operator interface, depending on the embodiment. The unit consists of a touchscreen display or a set of mechanical regulators.

The Client Input Unit 900 may work by displaying a human face or outline of the appropriate age and gender, allowing the client to mark or select areas of concern and choose from a pre-defined set of beauty goals. In some embodiments, a picture of the client's face and neck is captured and displayed on the screen of the Client Input Unit, where the client can mark the areas of interest. This information is digitized and relayed to the Central Processing Unit 600.

In addition, the Client Input Unit 900 interacts with the Personal Beauty Key (PBK) 1000 of the client. It can read the PBK and display the client's previous beauty care goals and the results of past beauty procedures. This allows the client to see their beauty care progress over time and adjust their beauty care goals accordingly. In some embodiments, the Client Input Unit 900 is aided by a software module that allows the client to define their goals more accurately or visualize the potential results of the beauty procedures. If the client interface 120 is unavailable or has not been activated, the Client Input Unit 900 is configured to perform one or more functions of the client interface 120.

The Client Input Unit 900 provides a personalized and interactive experience for the client, enabling them to actively participate in defining their beauty goals. This enhances client engagement and ensures that the beauty procedures recommended by the device align with the client's specific needs and expectations. Furthermore, the interaction with the PBK provides a personalized and longitudinal approach to beauty care, enhancing the client's experience and the effectiveness of the recommended procedures.

### Personal Beauty Key (PBK) 1000

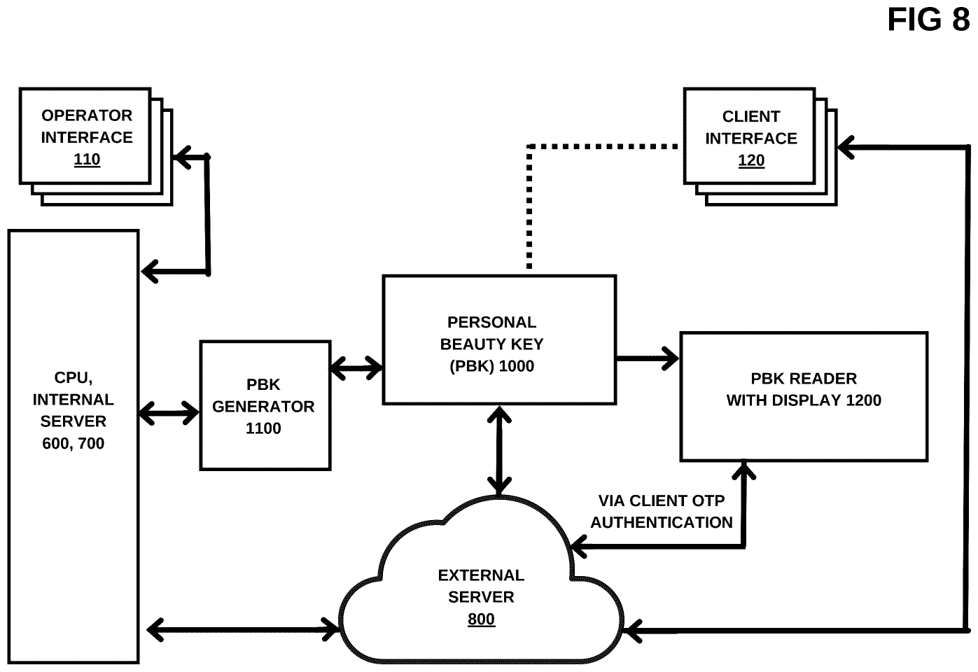

FIG. 8 is a block diagram that illustrates the components of the Personal Beauty Key subsystem and the flow of data through the subsystem, according to an embodiment of the present disclosure. As depicted in FIG. 8, in preferred embodiments the Personal Beauty Key (PBK) 1000 is a unique component of the Personal Beauty Key Subsystem, configured to encapsulate each client's personalized beauty data. It serves as a digital representation of the client's beauty profile, including their face characteristics, beauty goals, and history of procedures and product usage. The PBK 1000 is instrumental in providing tailored beauty care recommendations, ensuring that each client receives a personalized and longitudinal approach to beauty care.

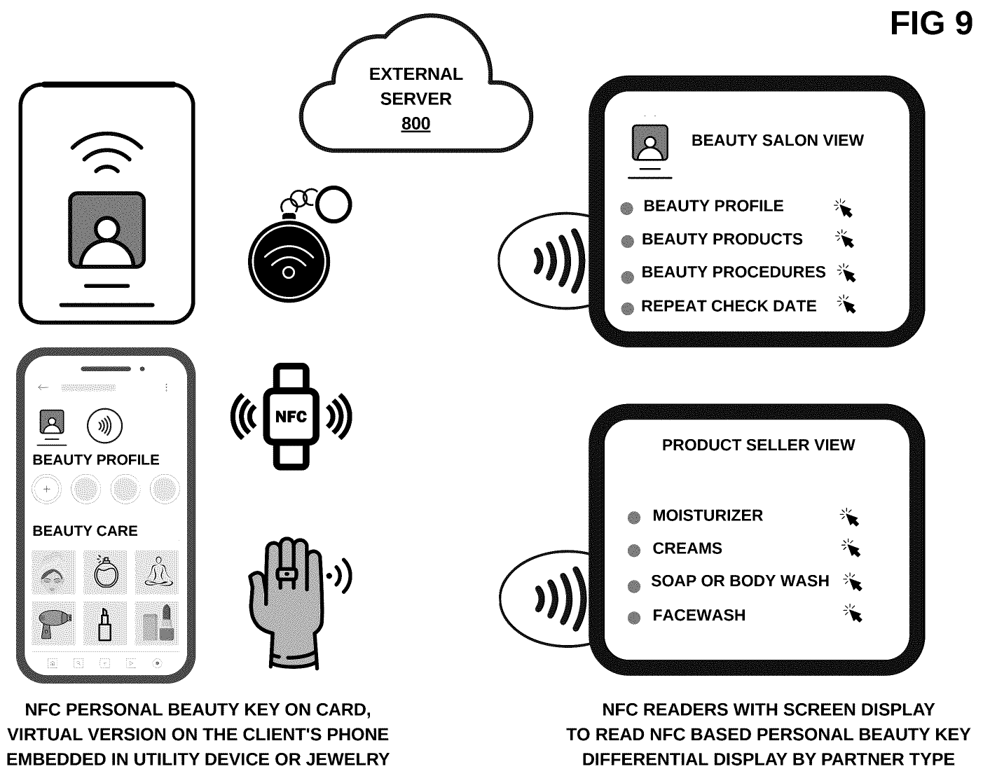

FIG. 9 is an illustration of the varied possible manifestations of the Personal Beauty Key and the Display screen of the Personal Beauty Key Card Reader, showing differential information display between a beauty salon and a beauty product seller, according to an embodiment of the present disclosure. As depicted in FIG. 9, The PBK may exist in two versions: digital and physical. The digital PBK is a secure data file stored within the client's mobile device, with an easy to understand front end interface, which may be a purpose built mobile application. It can be accessed by using a security code. The physical PBK, on the other hand, is a tangible object, such as a card or a utility device or jewellery, embedded with a NFC chip or a QR code or a barcode. It can synchronize with the purpose built mobile application, associated with the virtual PBK. The PBK 1000 can be carried by the client and used at beauty salons and spas equipped with a compatible PBK reader 1200, ensuring continuity of personalized care across different environments. It also serves as an objective appointment setting and scheduling resource.

In preferred embodiments, the PBK 1000 is programmed to provide differential information to different stakeholders in the client's beauty care routine as is appropriate for the stake holder. For example, the information provided by the client's PBK 1000 to an access request by the PBK reader 1200 at a beauty salon may be very different than the information provided to an access request by the PBK reader at a beauty product shop. The information access levels may also be concurrently controlled by the client. In some embodiments, the PBK 1000 virtual version in association with an approved mobile application helps the client to purchase beauty products at physical stores or on e-commerce websites. The client may use the PBK 1000 linked APP of the PBK embedded mobile device to click a photograph of the beauty product or upload a picture of the beauty product, or type In the details of the beauty product. This data is passed to the external server 800, wherein it is matched against a pre-existing database of beauty products and the data related to the client's PBK 1000 to generate an opinion on the suitability of the product. This information is relayed back to the client through the PBK linked Mobile App. It is also possible for beauty products to display PBK 1000 compliant QR codes on their packaging. These codes could be scanned by the client as described above for a faster opinion on the suitability of the product to them. The PBK system could integrate with e-commerce platforms to allow clients to directly purchase recommended beauty products. This would provide a seamless shopping experience and ensure that clients are purchasing the correct products for their specific beauty needs. The PBK 1000 could also integrate with virtual assistants presently available on the market like Amazon's Alexa or Google Assistant. In some embodiments, the virtual PBK 1000 could integrate with smart home devices or mobile apps to track environmental factors that could impact beauty, such as air quality or humidity levels. This data could be used to provide more comprehensive and personalized beauty care recommendations through the PBK 1000. In an embodiment of the invention, the IoT compatibility of the Personal Beauty Key (PBK) system allows for interaction with a diverse range of smart devices, thereby creating a more integrated and personalized beauty care experience for clients. The following are some potential implementations of this embodiment:

Smart Mirrors: In this implementation, smart mirrors equipped with cameras and sensors could perform real-time analysis of a client's beauty and display the results directly on the mirror. The PBK system could synchronize with these mirrors, leveraging the analysis to provide personalized beauty care recommendations. Smart face care Devices: In another implementation, smart face care devices such as smart facial brushes or smart beauty masks could be synchronized with the PBK system. These devices could utilize the client's PBK data to adjust their operation in accordance with the client's specific needs. For instance, a smart facial brush could modulate its speed and pressure based on the data derived from the client's PBK.

Smart Bathroom Scales: These scales could be employed to monitor changes in the client's body composition over time. The PBK system could leverage this data to recommend beauty procedures tailored to the client's current physical condition.

Smart Watches and Fitness Trackers: These devices could furnish data on the client's physical activity, sleep patterns, heart rate, and other health metrics. The PBK system could utilize this data to provide more holistic beauty care recommendations. For instance, if the client's sleep data indicates poor sleep quality, the PBK system could recommend beauty regimes that address the effects of sleep deprivation on the facial beauty.

Smart Home Systems: The PBK system could integrate with smart home systems to create a more immersive beauty care experience. For example, the system could adjust the lighting in the client's home based on the time of day or the specific beauty procedures the client is performing. The PBK 1000 interacts seamlessly with other components of the device. It communicates with the CPU 600 and the external server 800 for data processing and analysis, the Client Input Unit for capturing the client's beauty goals, and the PBK generator 1100 for reading and updating the PBK data. The security and privacy of the data contained in the PBK are protected.

The PBK 1000, with its personalized and interactive approach, enhances client engagement, improves the effectiveness of the recommended procedures. By integrating with IoT devices, the PBK subsystem could provide a more comprehensive and personalized beauty care experience that extends beyond the confines of a beauty salon or spa.

### The Personal Beauty Key (PBK) Generator 1100

In preferred embodiments, the generation of the PBK 1000 is managed by a PBK Generator 1100, which is a part of the Central Processing Unit (CPU) 600 of the device. The PBK Generator is capable of generating, reading and modifying a PBK 1000. In some embodiments the PBK generator could be a software component within the CPU that generates a unique PBK for each client in synchronization with the external server 800. In preferred embodiments the PBK generator has a QR code printer or a NFC chip activator. In the case of a digital PBK, the PBK could be sent as a digital card to the client via email, a messaging system, or through a mobile app if client has downloaded an approved mobile app on their mobile device. In preferred embodiments the beauty salon or spa could create the physical PBK on-site by generating a QR code sticker that could be affixed on to a PBK card or by activating a NFC chip mounted on a pre-existing card or any approved physical carrier. The physical PBK could be given to the client immediately after their beauty data has been analyzed and their PBK has been generated. In alternative embodiments, if the physical PBK needs to be produced off-site, it could be mailed to the client's address. The PBK 1000 is updated over time based on new data and analysis results, ensuring that the beauty care recommendations always align with the client's current needs and preferences.

### The Personal Beauty Key (PBK) Reader 1200

In preferred embodiments in the PBK reader 1200 is a custom made device that can read, interpret and relay the data stored in both the digital and physical versions of the PBK 1000. In some embodiments the PBK reader 1200 could be an authorized custom made mobile app that is downloaded and activated on a mobile device of specific configuration. The PBK reader 1200 is made available to various beauty stakeholders like beauty salons, cosmetic product sellers, whom the clients might interact with for their beauty care. All PBK readers are registered in a database maintained in the external server.

On connecting with a PBK 1000 the PBK reader 120 may transmit the data from the PBK 1000 to the external server 800 for further processing and receive relevant inputs from the external server 800 in relation to the PBK 1000. The PBK reader may also feature a user interface that provides feedback to the beauty stakeholder about the status of the PBK reading process, displaying messages or alerts related to the PBK 1000 data.

A key aspect of the PBK Reader 1200 is its security measures. It employs data encryption and secure data transmission protocols to ensure that the PBK data is read and transmitted securely. This is particularly important given the personal nature of the data contained within the PBK. To ensure its functionality, security, and accuracy, the PBK Reader is capable of receiving software updates.

### Method of Implementation:

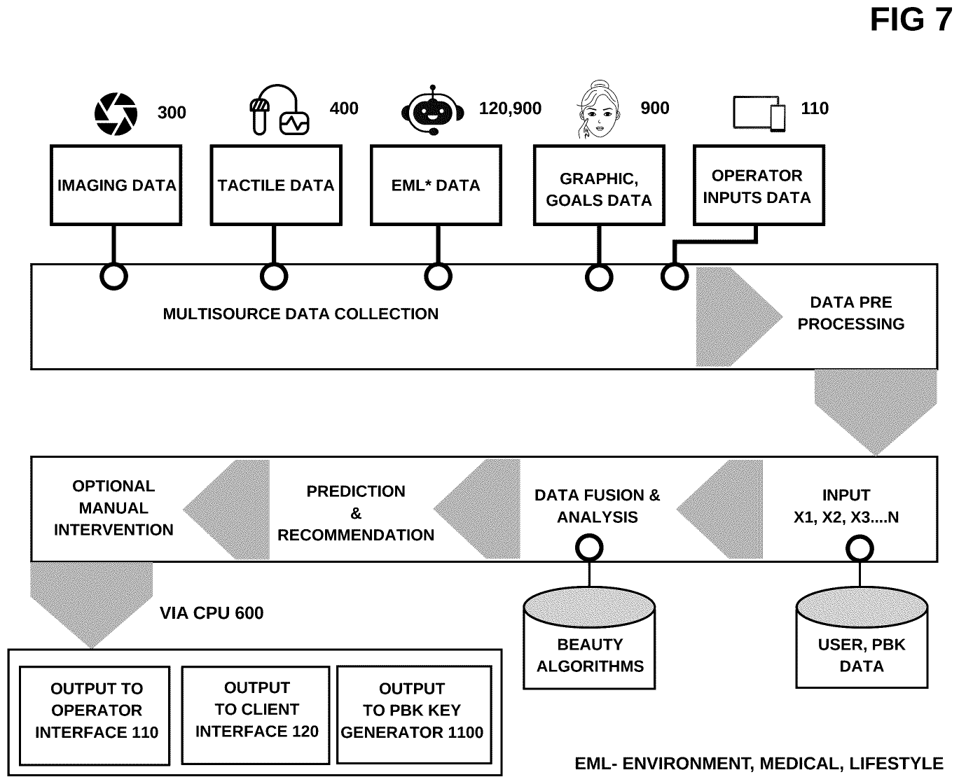

As Depicted in FIG. 7, and FIG. 1B the method initiates with a computer-implemented process for beauty analysis and client engagement. The process is facilitated by functional subsystems as depicted in FIG. 1B, which include a data acquisition subsystem (D), a communication subsystem (C), a lighting control mechanism (L), a software module (S), a Personal Beauty Key subsystem (P), and a manage/control system (M). The process is further elaborated in FIG. 7 illustrating the transformation of acquired data to actionable output.

The data acquisition subsystem (D) collects various types of data about a client's face and neck. This includes imaging data from static images and dynamic videos, non-imaging data from devices such as tactile sensors or non-contact sensors, operator and client inputs, historical data related to the client's beauty conditions, and environmental data including climate, pollution, and other environmental parameters.

The communication subsystem (C) enables real-time interaction with client during the data acquisition process through audio and visual means. This real-time engagement, in addition to objective data and graphical reports, is configured to help clients understand their beauty needs and for salon professionals to convince clients about the need for specific beauty procedures.

Once the data is collected, it is transferred to an internal server and an external server configured to receive, process, store and transmit data from the device. The data is processed through a custom designed, device linked, multimodal fusion algorithm in the software module (S). This algorithm integrates text, image, and environmental data to infer the marginal probability of beauty aspects. The software module (S) also includes a machine-learning model for multimodal fusion-based deep learning networks, specifically designed for effective beauty analysis using the device. This model includes a convolutional neural network (CNN) for processing and extracting features from imaging data, a recurrent neural network (RNN) or long short-term memory (LSTM) network for processing and extracting features from non-imaging data, client inputs, and environmental data, a fusion layer for integrating the features extracted from the CNN and RNN/LSTM networks, and an output layer for generating results based on the integrated features, including the marginal probability of beauty aspects.

The processed data is then used to generate a personalized, dynamic beauty guide in the form of a Personal Beauty Key (PBK) for each client in the Personal Beauty Key subsystem (P). The PBK is in a physical and virtual form. It encapsulates the client's personalized beauty data as generated by the device and is used to provide tailored beauty care information to the client and beauty stakeholders. The PBK generation process is a secure and privacy-focused procedure that creates unique Personal Beauty Keys (PBKs) for each client. This process involves stringent security measures for physical PBK production, and secure communication channels for digital PBK transmission. The process also includes secure mailing procedures for optional off-site physical PBK production.

The Personal Beauty Key is linked to a user interface on the client's mobile device. The user interface may allow the client to track their progress over time and provides additional beauty care resources and PBK linked controls. The PBK can be used at multiple PBK readers and IoT linked devices to receive and transmit information to them.

This method is designed with a focus on aesthetics, personalized recommendations, and follow-up capabilities, while ensuring that it remains within the bounds of beauty care and does not involve medical diagnosis or treatment. It provides an objective way for beauty salons to recommend procedures and offers a system for longitudinal care of a client.

FIG. 10 illustrates a method 50 for providing personalized beauty profiling and guidance to a user, according to an embodiment of the present disclosure. FIG. 10 illustrates a method 50 performed by the device 100 and its components for providing personalized beauty profiling and guidance to a user, in accordance with an embodiment of the present disclosure. The method 50 can be performed by programmed computing devices, for example, based on instructions retrieved from non-transitory computer readable media. The computer readable media can include machine-executable or computer-executable instructions to perform all or portions of the described method. The computer readable media may be, for example, digital memories, magnetic storage media, such as magnetic disks and magnetic tapes, hard drives, or optically readable data storage media.

The method 50 includes a series of operations shown at step 52 through step 56 of FIG. 10. The method 50 may be performed by the device 100 in conjunction with the plurality of modules 10, the details of which are explained in conjunction with FIG. 1 to 2, and the same are not repeated here for the sake of brevity in the present disclosure. The method 50 begins at step 52. At step 52, the method 50 includes acquiring data associated with the user. At step 54, the method 50 includes processing the acquired data for generating a personalized module 16 for providing personalized beauty profiling and guidance to the user, wherein the personalized module 16 comprises a device generated data file 16A encapsulating the user's personalized beauty condition. At step 56, the method 1200 facilitating active beauty care through the personalized module 16 by interfacing the personalized module 16 with one or more of dedicated devices for providing differential information to different stakeholders. Further, the details regarding the operation of each step (52-56) are illustrated in detail in FIGS. 1,1A-1C and hence have not been detailed for sake of brevity.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

We claim:

1. A device (100) for providing personalized beauty profiling and guidance to a user, the device (100) comprising:
a) a data acquisition subsystem (11), comprising one or more multimodal modules (11A) configured for acquiring data associated with the user; and
b) a processing subsystem (12A) configured for: processing the acquired data for generating a personalized module (16), for providing personalized beauty profiling and guidance to the user, wherein the personalized module (16) comprises a device generated data file (16A) encapsulating the user's personalized beauty condition, and facilitating active beauty care through the personalized module (16) by interfacing the personalized module (16) with one or more of dedicated devices for providing differential information to different stakeholders.

2. The device (100) as claimed in claim 1, wherein processing the acquired data for generating the personalized (16) module comprises,
a) integrating the acquired data received from the one or more multimodal modules (11A),
b) applying machine learning techniques, or any other suitable methods to the integrated data for analysing and generating results of analysis,
c) facilitating optional expert validation on the generated results,
d) using the generated results for generating the device generated data file (16A), and
e) presenting the device generated data file (16A) to the user through a communication sub-system or other device interfaces.

3. The device (100) as claimed in claim 1, comprises an upgrading module configured for periodically integrating additional data inputs acquired by the data acquisition subsystem (11), processing the additional data for dynamically updating the personalized module (16).

4. The device (100) as claimed in claim 1, wherein the active beauty care comprises one or more of providing personalized recommendations on skincare to the user comprising facial dimensions, dermatological treatments, cosmetic procedures, medical interventions, or any other relevant applications based on the generated results.

5. The device (100) as claimed in claim 1, wherein the personalized module (16) is one or more of:
a) an IoT based storage module is configured as a physical Personal Beauty Key, embedded with the device generated data file (16A) encapsulating the user's personalized beauty condition,
b) a virtual storage module is configured as a virtual counterpart of the personal beauty key, stored as a secure, encrypted data file within the user's user device, the user device comprising the device generated data file (16A) encapsulating the user's personalized beauty condition,
c) a remote based storage module, accessible by the Personal Beauty Key through an application installed on the user device, configured to store, update, and process the device generated data file (16A) encapsulating the user's personalized beauty condition,
d) a set of devices embedded with readers devices enabling personalized beauty related communication and the reading of user beauty information, and
e) an on-demand Interactive Voice Response based beauty concierge service, linked to the Personal Beauty Key, configured to provide personalized beauty care guidance to the user.

6. The device (100) as claimed in claim 1, wherein the personalized module (16) comprises a physical or virtual Personal Beauty Key Reader (1200) for securely accessing the contents of the Personal Beauty Key and for displaying stakeholder specific beauty care recommendations related to the user, the Personal Beauty Key Reader (1200) comprising:
a) a scanning component capable of reading a user's Personal Beauty Key,
b) a display component for presenting the personal beauty needs of the user to the beauty stakeholders upon scanning the personal beauty key,
c) a wired or wireless transmitting module programmed to facilitate data exchange between the Beauty Key Reader and the remote server associated with the device (100),
d) a custom built stakeholder interface for allowing the beauty stakeholders to upload their products and services to the database of the device (100), and
e) a device specific, beauty stakeholder ID protocol that facilitates the differential output by the Beauty Key Reader of user specific instructions to the beauty stakeholders, such as one or more of a suitable product or a service to be provided along with the ingredients to be used.

7. The device (100) as claimed in claim 1, wherein the one or more multimodal modules (11A) configured for acquiring data associated with the user, in near real-time comprises:
a) an imaging module (300) for guiding, detecting, capturing, and analysing beauty characteristics on the user's face and neck during dynamic facial movements, with the analysis focused on aesthetic aspects such as skin texture, colour uniformity, and visible signs of aging or environmental damage,
b) a non-imaging module (400) that is one of non-invasive, tactile, and contact type is configured for obtaining skin measurements of the user, and
c) a user input module (900) configured for allowing the user to indicate specific areas of concern on a facial image.

8. The device (100) as claimed in claim 1, wherein the device (100) comprises the communication sub-system comprising one or more interaction components configured for human or machine-based interaction with the user during the data acquisition process, the interaction components comprise, but not limited to:
a) a viewer (250) or visual display component configured for viewing the face or other related information associated with the user,
b) a two-way audio component configured for allowing verbal communication between the user, the device or the device operator,
c) one or more of a screen and a reciprocal concave mirror configured for allowing the user to view their face during the data acquisition process, and
d) an interaction component selected from a group comprising a haptic feedback and text-based messaging.

9. The device (100) as claimed in claim 1, wherein the communication subsystem is configured for displaying a portion of the acquired data on the one or more display components, while communicating with the user in real-time, including about the data displayed on the screen, during the data acquisition process through live interaction or machine-driven commentary.

10. The device (100) as claimed in claim 1, wherein the device (100) comprises a lighting control subsystem configured for creating a dynamically controlled lighting environment around the user and is mounted on a telescopic light stands, each stand having a top and bottom component connected with a joint that allows for angular movement of the top component, wherein the telescopic stands of the dynamic lighting mechanism are set in a structure that allows for movement in a fixed path to achieve appropriate light focus on the user's face.

11. The device (100) as claimed in claim 1, wherein the lighting control subsystem is one or more of a retractable cover module (500), a dynamic lighting units, a lighting output adjusters (240), a plurality of lights arranged around the viewing area, wherein the retractable cover module (500) is configured with a retractable framework (510), that is controlled with a movement mechanism, optionally guided by a remote control to create a transient, light-controlled, private space in various shared environments, such as public halls, salons, spas, dormitories, or hospital wards.

12. The device (100) as claimed in claim 1, wherein the device (100) comprises a plurality of contact probes integrated, charged, and stored in a slot in the device (100) for obtaining cosmetic skin measurements related to beauty aspects, wherein the plurality of contact probes are held on robotic arms which are externally guided to enable the probes to touch the appropriate areas on the user's face, with the understanding that these measurements are in the nature of beauty analysis.

13. A method (50) for providing personalized beauty profiling and guidance to a user, the method (50) comprising:
a) acquiring (52) data associated with the user,
b) processing (54) the acquired data for generating a personalized module (16) for providing personalized beauty profiling and guidance to the user, wherein the personalized module (16) comprises a device generated data file (16A) encapsulating the user's personalized beauty condition, and
c) facilitating active beauty care through the personalized module (16) by interfacing (56) the personalized module (16) with one or more of dedicated devices for providing differential information to different stakeholders.

14. The method as claimed in claim 13, wherein facilitating active beauty care through the personalized module (16) comprises:
a) connecting the Personal Beauty Key with environmental sensors using an environment tracking module,
b) receiving data related to environmental factors that impact beauty, and transmitting this data to a remote server,
c) executing functions required for the operation of the Personal Beauty Key using an application installed on a user device, including accessing the Personal Beauty Key, controlling the access level of beauty stakeholders, and interacting with the e-commerce integration and environmental tracking module, and
d) engaging with the user by collecting environmental and other data, providing instructions to beauty instruments through IoT.

15. The method as claimed in claim 13, wherein acquiring data associated with the user in near real-time or real time or non-real time comprises the steps of:
a) receiving imaging data associated with the user's face and neck, including static images and dynamic videos,
b) receiving a plurality of non-imaging data associated with the user from various analytical devices, such as tactile sensors or non-contact sensors,
c) receiving operator and user inputs, as well as historical data related to the user's skin conditions, and
d) receiving environmental data, including climate, pollution, and other environmental parameters.

16. The method as claimed in claim 13, wherein processing the received data through a multimodal fusion module configured to integrate text, numerical, image, and environmental data to infer the marginal probability of skin conditions.

17. The method as claimed in claim 13, comprising simultaneously displaying a portion of the received data on one or more display units, while communicating with the user, including the data displayed on the screen, during the data acquisition process through live interaction or machine-driven commentary.

18. The method as claimed in claim 13, wherein providing personalized beauty profiling and guidance to the user comprises providing a plurality of treatment recommendations across the spectrum of cosmetology and dermatology in the form of a comprehensive treatment plan for achieving faster and better impact, such as, personalized skincare regimen, cosmetic procedures, oral medicines, diet, facial yoga and any other modality, based on the analytical outputs and user preferences.

19. The method of as claimed in claim 13, further comprising providing a platform for remote consultations with dermatology experts or other professionals, utilizing graphic and non-graphic output of the device generated data file (16A) or enabling the user to discuss their analytical results and receive personalized advice through a video call using the user input unit or the user interface.

20. A system for enabling a Personal Beauty Key in an Internet of Things environment, the system comprising:
a) an integrated device equipped with a Personal Beauty Key generator configured for creating an IoT compliant Personal Beauty Key in both physical and digital formats;
b) a Personal Beauty Key reader, comprising one or more modules configured for scanning the Personal Beauty Key, retrieving and transmit the scanned data to an associated remote server and displaying data to a user received from the remote server; and an IoT interface, specifically configured for Personal Beauty Key-linked aspects, configured to enable bi-directional information transfer from the Personal Beauty Key to approved IoT beauty care devices.
